(19) United States
(12) Patent Application Publication
(10) Pub. No.: US 2026/0278556 A1
(43) Pub. Date: Sep. 17, 2026

(54) SYSTEM

(71) Applicant: SoftBank Group Corp., Tokyo (JP)

(72) Inventor: Fumitaka YAZAMA, Tokyo (JP)

(73) Assignee: SoftBank Group Corp., Tokyo (JP)

(21) Appl. No.: 19/554,735

(22) Filed: Mar. 3, 2026

Related U.S. Application Data
(60) Provisional application No. 63/771,362, filed on Mar. 13, 2025.

(51) Int. Cl. G06Q 10/107; G06F 40/169; G06F 40/232; G06N 3/045

(52) U.S. Cl. CPC G06Q 10/107; G06F 40/169; G06F 40/232; G06N 3/045

(57) ABSTRACT

A system includes a processor that is configured to receive an instruction from a user and, based on the instruction, automatically generate a draft of a business email by using a natural language processing technique, analyze grammar of the generated business email so as to detect a spelling error, a punctuation error, and an inconsistency in a grammatical structure and automatically correct the generated business email based on a result of the analysis, and check content of the generated business email to determine whether the content complies with a compliance standard of an enterprise and to perform confirmation of prevention of leakage of confidential information and confirmation of appropriate wording.

### CROSS-REFERENCE TO RELATED APPLICATION

This application claims the benefit of U.S. Provisional Application No. 63/771,362 filed on Mar. 13, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for creating business emails require users to manually draft, proofread, and review email content, which is time-consuming and highly dependent on individual writing skills. In particular, manual drafting often leads to inconsistency in tone and format across an organization, and users must repeatedly perform grammar checking and style adjustment by themselves. Furthermore, conventional systems do not sufficiently support automatic detection of compliance issues, such as the inclusion of confidential information, inappropriate wording, or expressions that do not conform to corporate policies and regulations. As a result, there is a risk that non-compliant emails may be sent externally, which can cause information leakage, reputational damage, or legal problems for an enterprise. Therefore, there is a need for a system that can automatically generate drafts of business emails based on user instructions, automatically perform grammar checking and correction, and automatically check compliance with corporate standards, while still allowing the user to review and manually adjust the final email content.

### SUMMARY

In order to solve the above-described problems, according to one aspect of the present invention, there is provided a system comprising a processor, wherein the processor is configured to receive an instruction from a user and, based on the instruction, automatically generate a draft of a business email by using a natural language processing technique, analyze grammar of the generated business email so as to detect a spelling error, a punctuation error, and an inconsistency in a grammatical structure and automatically correct the generated business email based on a result of the analysis, and check content of the generated business email to determine whether the content complies with a compliance standard of an enterprise and to perform confirmation of prevention of leakage of confidential information and confirmation of appropriate wording. In one embodiment, the processor is further configured to analyze the instruction from the user by using the natural language processing technique, to create the business email with a context and a tone appropriate to the instruction, and to generate the draft of the business email that accurately reflects an intention of the user by using a pre-trained language model. In another embodiment, the processor is further configured to detect a specific keyword or phrase in the content of the business email, to display a warning and present a correction proposal when there is a possibility that the content of the business email violates the compliance standard of the enterprise, and to provide an interface through which the user is enabled to review a final draft of the business email and manually modify the final draft as needed.

The term “system” refers to an arrangement of hardware and software components including at least one processor configured to execute instructions for performing the functions described in the claims.

The term “processor” refers to any type of computing element, including but not limited to a central processing unit (CPU), a graphics processing unit (GPU), a digital signal processor (DSP), or a combination of such elements, that executes program code to implement the claimed functions.

The term “user” refers to a human operator who interacts with the system by providing instructions, reviewing generated email drafts, and optionally editing or approving the final email content.

The term “instruction from a user” refers to information input by the user, including at least an indication of a purpose, content, or context of a business email to be generated, which the system uses as a basis for generating a draft of the business email.

The term “business email” refers to an electronic mail message created for business or professional communication within or outside an enterprise, and including at least a subject and a body of text.

The term “draft of a business email” refers to a preliminary version of the content of a business email generated by the system, which may be reviewed, corrected, or modified before being finally sent.

The term “natural language processing technique” refers to any computational method or algorithm that analyzes, interprets, or generates human language text, including but not limited to tokenization, parsing, semantic analysis, and text generation.

The term “pre-trained language model” refers to a machine learning model that has been trained in advance on text data to learn language patterns and that is used by the processor to generate email text that reflects a user's intention.

The term “analyze grammar” refers to examining the syntactic and morphological structure of text in the business email to identify linguistic errors or inconsistencies.

The term “spelling error” refers to a deviation from a correct or standardized spelling of a word in the language used in the business email.

The term “punctuation error” refers to incorrect, missing, or misplaced punctuation marks in the business email that result in grammatically or stylistically improper text.

The term “inconsistency in a grammatical structure” refers to a phrase or sentence structure that does not conform to grammatical rules of the language, thereby causing ungrammatical or ambiguous expressions in the business email.

The term “automatically correct” refers to modifying the text of the business email by the processor without requiring manual intervention from the user, in order to correct detected errors.

The term “content of the business email” refers to the textual information included in the body and, optionally, the subject of the business email that is generated, analyzed, and potentially corrected by the system.

The term “compliance standard of an enterprise” refers to a set of rules, policies, guidelines, or legal requirements defined by or applicable to an enterprise that governs acceptable content, expressions, and handling of information in business emails.

The term “prevention of leakage of confidential information” refers to measures taken by the system to identify and reduce the risk that sensitive data, trade secrets, or other proprietary information will be improperly disclosed through a business email.

The term “appropriate wording” refers to expressions, phrases, and tone in the business email that comply with corporate policies, legal regulations, and generally accepted business etiquette.

The term “context and tone appropriate to the instruction” refers to the overall style, formality level, and semantic framing of the business email that match the user's intended purpose and situation indicated by the instruction.

The term “intention of the user” refers to the purpose, meaning, and communication objective that the user wishes to convey through the business email, as derived from the user's instruction and related input.

The term “specific keyword or phrase” refers to a predetermined word, sequence of words, or expression in the business email that is associated with compliance risk, such as confidential terms, prohibited expressions, or sensitive terminology.

The term “warning” refers to information presented to the user indicating that a portion of the business email may not comply with the compliance standard of the enterprise or may otherwise be inappropriate.

The term “correction proposal” refers to a suggested modification or alternative wording provided by the system for replacing or revising a portion of the business email that is considered problematic.

The term “interface” refers to any graphical user interface, command-line interface, or other user interaction mechanism that allows the user to view, input, or modify information related to the business email.

The term “final draft of the business email” refers to the version of the business email that has undergone automatic generation, grammar checking, compliance checking, and optional user editing, and that is prepared for sending as an actual email message.

The term “manually modify” refers to editing or changing the content of the business email directly by the user through the interface without relying solely on automatic processing by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

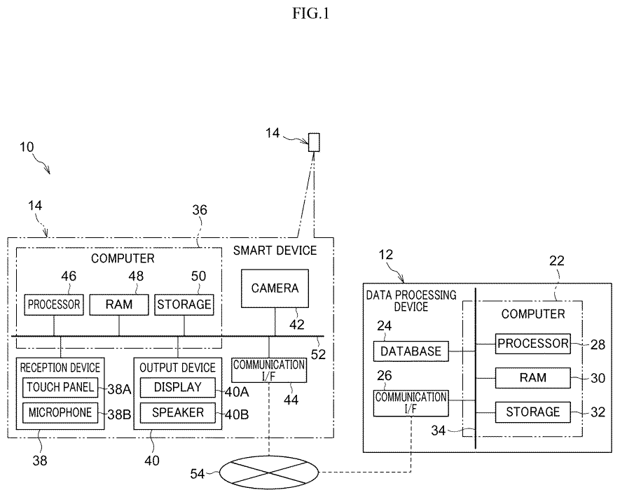

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

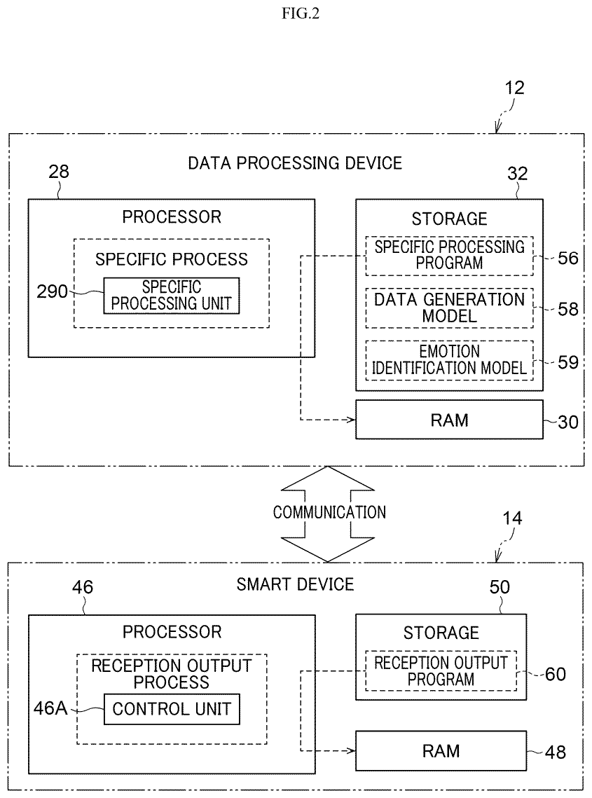

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for composing business electronic messages largely rely on manual authoring and ad hoc use of general-purpose text editors or isolated language tools. Even when natural language processing functions are used, such systems typically apply grammar checking or compliance checking as disconnected, post-processing steps to a static message body. As a result, such systems exhibit several technical limitations in terms of how computing resources are used to generate, correct, and validate text on a server in cooperation with a terminal device.

First, in conventional architectures, a server often receives an already composed message body from a terminal device and then sequentially invokes independent services such as a grammar checker or a compliance checker. Because the server has no structured representation of the user's intent or meta information (for example, application type, recipient attribute, writing style type, language type), the server cannot construct optimal input for a generative AI model or other language processing components. This leads to redundant network traffic, repeated computation on similar text, and inefficient usage of processing resources on the server.

Second, many existing systems invoke a generative AI model in a simplistic way, by directly passing a free-form instruction or a partially composed message as input. Without a systematic mechanism to construct a detailed prompt sentence from structured information and meta information, the generative AI model may generate text having inappropriate tone, incomplete content, or noncompliant expressions. To correct such output, separate grammar and compliance tools must be repeatedly invoked, causing duplicated analysis of the same text, increased latency, and inconsistent modification history within the server.

Third, conventional systems often treat grammar correction, compliance checking, and user interaction as separate functions with minimal integration. A grammar checker may correct text without preserving a relationship between original and corrected segments, and a compliance checker may merely flag problematic phrases without providing machine-generated alternatives. On the terminal device, the user typically sees only a final corrected text, with limited ability to understand which server-side processes were applied or to iteratively refine the text through additional instructions. This fragmented design prevents efficient round-trip editing between the terminal device and the server and prevents the server from leveraging the generative AI model to perform targeted re-generation only on problematic portions.

Fourth, in many known email authoring tools, the preparation for message transmission (including validation of address formats, subject lengths, and attachment constraints) is implemented as a separate client-side routine or as a simple server-side check. These components do not integrate the preceding language processing pipeline and, therefore, cannot reuse structured information, correction histories, or compliance metadata computed by the server. This fragmentation causes repetitious validation, increases error handling complexity, and makes it difficult to ensure end-to-end consistency from initial instruction input to final message transmission.

Accordingly, there is a need for a computer-implemented technique that integrates (i) structured acquisition of user instruction information, (ii) generation of detailed prompt sentences for a generative AI model, (iii) server-side grammar correction and compliance checking with explicit tracking of correction candidates, and (iv) interactive editing and final transmission preparation in cooperation with a terminal device. Such a technique should improve how a server organizes and reuses linguistic and meta information, reduce redundant computations across multiple language processing steps, and provide an interactive editing loop that leverages a generative AI model in a controlled and auditable manner. By addressing these issues, computing devices can more efficiently generate, correct, and validate business electronic messages while maintaining compliance with organizational policies and communication standards.

The specific processing by the specific processing unit 290 of the data processing device 12 in Example 1 is realized by the following means.

The present invention provides a server comprising a processor configured to acquire instruction information including business information from a user via a terminal device, generate structured information including the instruction information, and generate a prompt sentence to be input to a generative AI model based on the structured information; to input the prompt sentence to the generative AI model and generate draft information of a business electronic message by performing text generation processing using a language model in the generative AI model; to perform sentence division processing and language structure analysis processing on the draft information, detect spelling errors, punctuation errors, and syntactic inconsistencies, and automatically correct the draft information based on detection results; to perform detection of specific expressions on automatically corrected draft information based on stored rule information and stored phrase information, determine conformity of the draft information to confidentiality protection criteria and expression criteria, extract a portion that violates or is likely to violate the criteria, generate warning information, and generate correction candidate information for rewriting a text portion associated with the warning information based on the generative AI model or replacement candidate data; to transmit display information including the automatically corrected draft information, the warning information, and the correction candidate information to the terminal device, and to control display on the terminal device so as to enable the user to view, manually correct, and provide additional instruction input for the draft information; and to acquire finalized electronic message information from the terminal device, verify conformity of address information, subject information, and attachment information to format conditions and constraint conditions, and transmit electronic message information determined to be transmittable to a message transfer device according to a transmission protocol. This enables integrated server-side processing that constructs and reuses detailed prompt sentences for the generative AI model, performs coordinated grammar correction and compliance checking with explicit correction candidates, supports interactive refinement between the server and the terminal device, and prepares and transmits business electronic messages with improved efficiency, consistency, and compliance compared to conventional computer-implemented messaging systems.

The term “instruction information” refers to information input by a user indicating at least a purpose, content, or condition of a business electronic message, including but not limited to short natural language commands, prompt sentences, and parameter selections specifying tone, recipient type, or language.

The term “business information” refers to information relating to a business context, including but not limited to meeting schedules, product information, project status, organizational roles, and communication objectives used as content or constraints for a business electronic message.

The term “structured information” refers to data in which user-provided information and related meta information are organized into a predetermined format, such as key-value pairs, records, or objects, enabling programmatic processing by a processor.

The term “prompt sentence” refers to a text sequence constructed from structured information and meta information and supplied as input to a generative AI model to control generation, rewriting, or refinement of a business electronic message.

The term “generative AI model” refers to a machine-learned model that receives a text input including a prompt sentence and outputs generated text based on statistical patterns learned from training data, such as a neural network language model.

The term “language model” refers to a component of a generative AI model that estimates probabilities of token sequences and performs text generation by predicting subsequent tokens based on preceding context.

The term “draft information” refers to textual and associated data representing a preliminary form of a business electronic message generated by the generative AI model prior to final user confirmation and transmission.

The term “sentence division processing” refers to processing that analyzes draft information and identifies sentence boundaries to partition the text into individual sentences for subsequent analysis or correction.

The term “language structure analysis processing” refers to processing that analyzes grammatical and syntactic structure of text, including at least part-of-speech tagging, phrase structure analysis, and dependency analysis.

The term “spelling errors” refers to character-level or word-level deviations from a predefined lexicon or orthographic rule set for a target language within the draft information.

The term “punctuation errors” refers to incorrect, missing, or extraneous punctuation symbols in the draft information, including but not limited to incorrect placement of commas, periods, and other punctuation marks.

The term “syntactic inconsistencies” refers to grammatical anomalies in sentence structure, including but not limited to incorrect word order, mismatched agreement between subject and verb, and improper use of conjunctions.

The term “rule information” refers to machine-readable data defining criteria for evaluating textual content, including but not limited to policies for confidentiality protection, prohibited expressions, and style or tone constraints.

The term “phrase information” refers to data representing words, terms, or multi-word expressions used as targets for detection, including sensitive terms, prohibited phrases, and terms requiring special handling.

The term “confidentiality protection criteria” refers to conditions specifying how textual content should avoid or appropriately handle references to confidential, secret, or sensitive information in accordance with organizational rules.

The term “expression criteria” refers to conditions specifying acceptable forms of language, including politeness level, avoidance of discriminatory or inappropriate expressions, and adherence to prescribed style guidelines.

The term “warning information” refers to information indicating a portion of the draft information that violates or is likely to violate rule information, confidentiality protection criteria, or expression criteria, and may include location, type of issue, and severity. The term “correction candidate information” refers to suggested alternative text or editing operations generated based on the generative AI model or predefined replacement data, for replacing or rewriting problematic portions of the draft information.

The term “display information” refers to data transmitted to a terminal device for presentation to a user, including at least the draft information, warning information, correction candidate information, and layout or formatting data.

The term “terminal device” refers to a computing apparatus operated by a user, including but not limited to a workstation, a portable terminal, or a mobile communication device, configured to send and receive information to and from a server.

The term “user display control function” refers to processing performed by the server to generate and transmit display information such that a terminal device presents content and interaction elements enabling user viewing, editing, and instruction input.

The term “additional instruction input” refers to supplemental information provided by the user after an initial draft has been generated, including but not limited to requests for tone change, summarization, expansion, or rewriting.

The term “finalized electronic message information” refers to information representing a business electronic message after user review and confirmation, including subject text, body text, address fields, and attachment information.

The term “address information” refers to data identifying message destinations in an electronic messaging system, including but not limited to primary recipient addresses, carbon copy addresses, and blind carbon copy addresses.

The term “subject information” refers to text representing a subject field of a business electronic message, used to summarize or identify the content of the message.

The term “attachment information” refers to data describing one or more files or content items associated with a business electronic message, including file identifiers, types, and sizes. The term “format conditions” refers to constraints defining acceptable syntactic or structural formats for fields of an electronic message, including but not limited to valid address formats and subject field length limits.

The term “constraint conditions” refers to limits or thresholds applied to message components, including but not limited to maximum attachment size, permitted file types, and maximum number of recipients.

The term “message transfer device” refers to a communication apparatus or service that receives electronic messages from the server and forwards the messages toward recipients using a messaging protocol, such as a mail transfer agent.

The term “transmission protocol” refers to a communication protocol used to send electronic messages from the server to the message transfer device, including but not limited to standardized mail transmission protocols.

The term “template information” refers to predefined text patterns or structures that can be combined with user-provided information and meta information to form a prompt sentence or draft content.

The term “user designation information” refers to information explicitly specified by the user, including the instruction information, additional instruction input, and other user-provided parameters that influence generation or correction of the message.

The term “meta information” refers to auxiliary information describing attributes of a message generation task, including but not limited to application type, recipient attribute, writing style type, and language type.

The term “application type” refers to a classification describing a use case of the business electronic message, such as a reminder, progress report, introduction, or inquiry.

The term “recipient attribute” refers to information describing characteristics of an intended recipient or recipient group, including but not limited to organizational role, internal or external relationship, and level of seniority.

The term “writing style type” refers to a classification indicating a desired stylistic property of the message, including but not limited to formality level, directness, and politeness.

The term “language type” refers to a specification of a natural language used for the message, such as a particular human language or regional variant.

The term “detailed prompt sentence” refers to a prompt sentence constructed by combining template information, user designation information, and meta information in a manner that explicitly instructs the generative AI model on desired content, tone, and structure of the message.

The term “corrected document generation process” refers to a process in which the generative AI model receives a detailed prompt sentence and outputs a modified version of draft information, including at least one of tone change, summarization, addition, or rewriting. The term “tone change” refers to modification of a message's style, such as making the message more formal, more casual, or more concise, while preserving core content.

The term “summarization” refers to generating a shorter form of a message that retains essential points while reducing length or detail.

The term “addition” refers to extending a message with supplementary content, such as additional explanations, sections, or clarifications.

The term “rewriting” refers to generating an alternative textual expression of a message or a portion thereof, while preserving intended meaning or constraints.

The term “server side” refers to an execution environment in which the server processor operates, distinct from processing performed on the terminal device, and responsible for implementing centralized language processing and message transmission functions. The term “regeneration process” refers to processing in which the generative AI model is invoked again for an existing draft information or a part thereof based on new instructions or selections, to produce updated draft information.

The term “interactive editing function” refers to a function that allows a user, via a terminal device, to iteratively modify, accept, or request regeneration of parts of draft information, while the server coordinates language processing and updates the displayed content.

In one embodiment, a server, a terminal, and a communication network together implement the system. The server includes at least one processor, a memory, a non-transitory storage medium, and a network interface. The processor executes program modules implementing a generative AI model, a prompt construction module, a grammar analysis module, a compliance analysis module, a display control module, and a transmission control module. The memory stores structured information, rule information, phrase information, template information, and meta information. The storage medium stores executable instructions and training data for a language model. The network interface provides communication with the terminal using a network protocol such as HTTP over TLS. The terminal includes a processor, a memory, an input/output interface, and a display unit. The terminal executes an application, such as a web browser or a native client, that renders user interface screens in markup language and script language. The terminal receives input from a user through a pointing device, a keyboard, or a touch panel and transmits user instruction information to the server. The user operates the terminal to specify information for a business electronic message and to review and modify draft text returned from the server. The server generates and executes a program that organizes user instruction information into structured information. The server stores the program as modules in a memory and loads the modules into a processor for execution. The server uses a programming language runtime, such as a general-purpose interpreter or virtual machine, and a server framework, such as an application framework, to implement network APIs and inter-module communication. The server uses a relational database management system or a document-oriented database system to store and retrieve rule information and log data.

The server uses the generative AI model to generate draft information of a business electronic message. In one implementation, the generative AI model includes a transformer-based neural network language model. The language model contains multiple layers of self-attention blocks and feedforward networks. Each layer applies multi-head attention that computes weighted sums of token embeddings based on learned query, key, and value matrices. The processor executes matrix multiplication operations on dedicated hardware, such as a general-purpose graphics processing unit. The language model is trained by minimizing a cross-entropy loss function between predicted token probabilities and actual tokens in training sequences. The server updates model parameters using a stochastic gradient descent method or a variant such as Adam, with mini-batching of training sequences and backpropagation through time.

The server represents input text and prompt sentences as sequences of integer token identifiers using a tokenizer, such as a subword tokenizer. The server maintains an embedding matrix that maps each token identifier to a continuous-valued vector. The server applies positional encodings to provide token order information. During training, the server uses data augmentation methods such as random masking of tokens, synonym replacement, or shuffling of non-critical clauses to improve generalization of the language model. The server trains the generative AI model on a corpus of business messages and related documents, thereby encoding statistical patterns relating to business language usage, tone, and structure. The server constructs a prompt sentence based on structured information and meta information. The server uses template information stored in the memory, where each template includes text patterns with placeholders. The server replaces placeholders with user instruction information and meta information such as application type, recipient attribute, writing style type, and language type. The server thereby generates a prompt sentence that constrains the generative AI model to produce text having a specified tone and content range. For example, the server constructs the following prompt sentences:

“Generate a formal business email reminding the recipient about a meeting next Monday at 10:00 a.m. Include a polite greeting, the meeting date and time, the meeting location, and a brief agenda.”

“Create a business email introducing a new product to existing customers. Use a polite and moderately formal tone, and include an overview section and a call-to-action section.”

“Rewrite the following email to be shorter and more formal while preserving all key points: [existing email body].”

“Draft a progress report email for an internal project update to management, summarizing completed tasks, ongoing issues, and next steps.”

The server, by constructing prompt sentences in this structured manner, reduces ambiguity in the input to the generative AI model and improves determinism and reproducibility of generated text. The server uses meta information to select an appropriate template and to adjust constraints for length, formality, and content coverage. As a result, the generative AI model operates with fewer iterations and less trial generation, thereby reducing computational load and network traffic between the server and the terminal.

The server uses the grammar analysis module to process draft information generated by the generative AI model. The server executes sentence division processing by scanning the generated text for sentence delimiters and by applying punctuation rules and statistical models to determine sentence boundaries. The server then executes language structure analysis processing using a parsing library or a custom parser. The server assigns part-of-speech tags to each token and constructs syntactic dependency graphs. The server stores these structures in memory using data structures such as adjacency lists and tagged token arrays. The server detects spelling errors by comparing each token to entries in a lexicon stored in a database and by computing edit distance between out-of-vocabulary tokens and candidate dictionary entries. The server detects punctuation errors by applying rule-based patterns that examine token sequences and punctuation positions. The server detects syntactic inconsistencies by evaluating dependency patterns against allowed syntax templates, and by computing scores using a trained classification model that distinguishes acceptable and unacceptable sentence structures.

The server automatically corrects draft information based on detection results. The server applies an algorithm that sorts correction candidates by position and type, then applies non-overlapping corrections in a defined order of priority. For spelling errors, the server selects replacement candidates having the smallest edit distance and highest language model probability. For punctuation errors, the server inserts or deletes punctuation symbols according to grammar rules. For syntactic inconsistencies, the server may rearrange word order or replace conjunctions using predefined replacement rules. The server stores the original and corrected versions of each sentence in a linked data structure that preserves mapping between original and corrected spans. This explicit mapping allows the server to track how corrections propagate through later processing steps and reduces the need to re-parse entire documents during iterative refinement.

The server uses the compliance analysis module to check the corrected draft information against confidentiality protection criteria and expression criteria. The server loads rule information and phrase information from persistent storage into in-memory data structures such as prefix trees and hash tables. The server scans the text token stream for sensitive phrases using string matching and pattern matching, including regular expressions. The server also uses an additional classifier, such as a neural network or a support vector machine, trained on labeled examples of compliant and non-compliant sentences. The server computes feature vectors from sentence embeddings produced by a smaller encoder network and feeds these vectors into the classifier to obtain a compliance probability score.

The server compares detected phrases and classification scores to thresholds stored in rule information. When the server determines that a portion of the draft information violates or likely violates a criterion, the server generates warning information that includes the character positions, the type of violation, and a severity level. The server then generates correction candidate information. In one implementation, the server constructs a prompt sentence such as:

“Rewrite the following sentence to remove confidential or sensitive wording and maintain a neutral, professional tone: [sentence].”

The server supplies this prompt sentence and the target sentence to the generative AI model. The language model generates alternative wording that omits sensitive terms but preserves business meaning. The server may compare the generated alternatives to a policy dictionary to confirm that the alternatives do not contain prohibited terms. The server stores the correction candidate information with references to the associated warning information.

The server transmits display information to the terminal. The display information includes the corrected draft text, annotations for grammatical corrections, compliance warnings, and available correction candidates. The server encodes this information in a structured response format. The terminal receives the display information and renders the draft text in a user interface. The terminal displays different categories of annotations using visual markers such as underlines and highlight colors. The user reviews the draft on the terminal and performs editing operations. The terminal transmits additional instruction input to the server when the user requests further modifications, such as changing tone, shortening text, or expanding a specific section.

The server, upon receiving additional instruction input, updates structured information and meta information and constructs a new detailed prompt sentence. The server performs a regeneration process by invoking the generative AI model with the updated prompt. The server can instruct the model to regenerate only a specified segment, using a constrained generation approach in which the server provides surrounding context and replacement boundaries. This segment-level regeneration reduces computational cost and preserves previously confirmed portions of the draft. The server updates the draft information and associated annotations and transmits updated display information to the terminal. The server prepares finalized electronic message information for transmission. The server validates address information by matching addresses against syntax patterns and, if configured, performing domain existence checks through network queries. The server validates subject information length and attachment information size according to constraint conditions. The server uses the same structured representation of message fields as used during earlier processing, thereby avoiding re-parsing and redundant format checks. This reuse of structured data reduces processing latency and potential errors introduced by repeated serialization and deserialization steps.

The server generates a message object that conforms to a standardized messaging format. The server constructs header fields, encodes the message body as text or multipart content, and attaches binary data for attachments according to the transmission protocol. The server then establishes a secure connection to a message transfer device using a networking library. The server transmits the formatted message and receives an acknowledgment from the message transfer device. The server logs transmission metadata such as timestamps, message identifiers, and status in a persistent storage system.

The described arrangement produces technical effects that extend beyond mere automation of human drafting tasks. The server enforces a particular data flow and data structure usage that reduces redundant text analysis and accelerates language processing. By constructing detailed prompt sentences from structured information and meta information, the server reduces the variability of model outputs and thereby decreases the need for multiple generation attempts. This saves computation time, reduces memory accesses, and lowers communication overhead between the server and the terminal. The explicit representation of correction mappings and compliance annotations in structured form allows the server to update only affected segments during regeneration rather than reprocessing the entire draft. This partial regeneration strategy, combined with segment-level evaluation of grammar and compliance, improves overall system throughput.

The use of integrated grammar parsing, compliance detection, and model-based rewriting changes how the computer system internally manages and transforms language data. Instead of treating each analysis tool as an isolated black box, the server coordinates intermediate representations and reuses syntactic graphs and phrase indices for multiple purposes. For example, the server can use dependency structures obtained during grammar analysis to determine sentence boundaries for compliance checks, and can reuse tokenization results for both spelling correction and phrase detection. This multi-use of intermediate data reduces redundant parsing operations and memory allocations, thereby improving computational efficiency at the system level.

The training and deployment of the generative AI model also contribute to improved technical performance. The server pre-trains and fine-tunes the language model on domain-specific corpora, thus increasing the baseline accuracy of generated business language. As a result, fewer grammar and compliance violations appear in the initial draft, which reduces the workload of downstream correction modules. The server tunes hyperparameters such as learning rate, batch size, and sequence length to achieve a balance between model capacity and inference speed on available hardware. The server may also use model quantization or pruning techniques to reduce the size of model parameters and accelerate inference without substantial loss of accuracy.

The system can be implemented in multiple variants. In one variant, the generative AI model executes on the same physical server that hosts the application logic, using a local accelerator. In another variant, the server acts as a client to a remote model-serving node that exposes an API for text generation. In a further variant, the grammar and compliance analysis modules use different algorithmic components, such as an entirely rule-based engine, a hybrid rule-and-model engine, or a fully model-based sequence labeling network. The server can select between these components based on message length, language type, or system load. Such dynamic selection can further reduce processing time and improve scalability.

The terminal may be any computing device capable of rendering interactive content. The terminal can be a stationary workstation, a portable information processing device, or a mobile terminal. The terminal can cache certain display templates and localization resources to reduce repeated downloads from the server. The user may operate multiple terminals under the same user identifier, and the server can store session state to resume editing across devices, thereby leveraging the structured representation of drafts and annotations.

Through these embodiments, the server, the terminal, and the generative AI model cooperate to provide a technically improved mechanism for generating, correcting, and transmitting business electronic messages. The system improves computational efficiency, reduces redundant operations, and enhances control over machine-generated text by using structured prompt construction, integrated linguistic analysis, and targeted regeneration. These technical features distinguish the system from conventional tools that merely provide automated text editing or generic email drafting assistance.

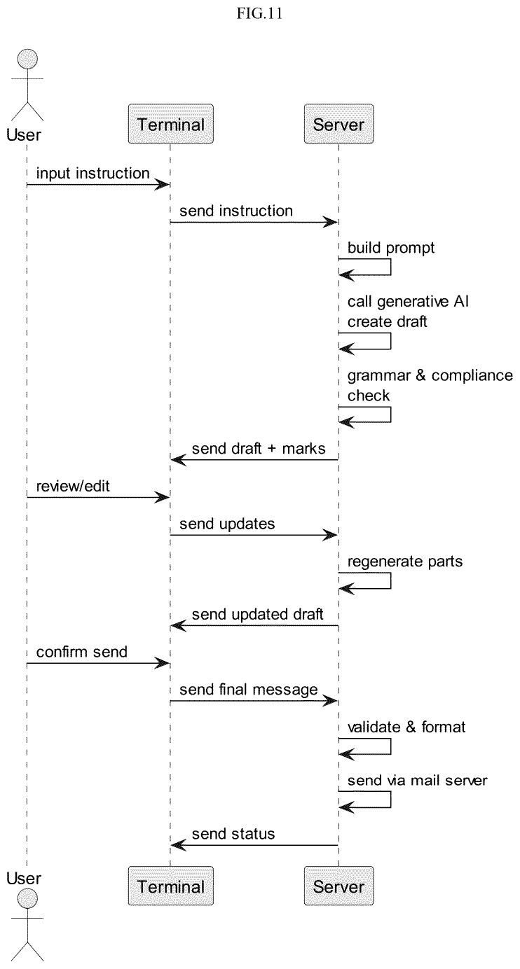

The following describes the processing flow using FIG. 11.

### Step 1:

The terminal displays an input screen to the user and receives instruction information. The terminal renders input fields (for example, text boxes and drop-down lists) and waits for user actions.

The user inputs a natural language instruction, such as “Draft a progress report email for this week,” and may select meta information, such as tone and language.

Input: raw user keystrokes, pointer events, and selection events.

The terminal converts these events into text strings and option values, groups them into a data structure (for example, a key-value map), and performs basic validation such as checking that required fields are not empty.

Output: validated instruction information and meta information stored in the terminal's memory.

### Step 2:

The terminal transmits the instruction information to the server.

Input: validated instruction information and meta information held by the terminal. The terminal serializes the instruction information into a message format, attaches a user identifier or session identifier, and sends the message to the server over a network protocol. The server receives the message at a network interface and decodes the serialized data into internal variables.

Output: structured instruction information and meta information stored in the server's memory.

### Step 3:

The server normalizes the received instruction information and generates structured information.

Input: raw instruction text and meta values stored in server variables.

The server applies text normalization operations, such as trimming whitespace, converting character encodings, and standardizing punctuation.

The server splits the instruction into tokens using a tokenizer and associates the tokens with fields such as purpose, target recipient, and constraints by applying simple pattern rules or a small classifier.

The server aggregates the normalized fields and meta values into a structured record (for example, an object with named attributes).

Output: structured information that represents the user's intent and context in a machine-readable form.

### Step 4:

The server constructs a prompt sentence from the structured information and meta information.

Input: structured information including purpose, key points, and meta information such as application type, recipient attribute, writing style type, and language type.

The server selects a template from a template repository based on the application type and recipient attribute.

The server replaces template placeholders (for example, “[PURPOSE]”, “[TONE]”, “[LANGUAGE]”, “[RECIPIENT]”) with concrete values taken from the structured information.

The server concatenates template fragments, fixed strings, and inserted values into a single text sequence, thereby forming a prompt sentence suitable for a generative AI model.

Output: a prompt sentence text string that explicitly instructs the generative AI model how to produce the desired business electronic message.

### Step 5:

The server performs tokenization and embedding preparation for the prompt sentence.

Input: prompt sentence text string produced in Step 4.

The server calls a tokenizer associated with the generative AI model to convert the prompt sentence into a sequence of token identifiers.

The server looks up each token identifier in an embedding table to obtain a corresponding vector representation and applies positional encodings to each token position.

The server assembles the embedding vectors into a matrix that represents the entire input sequence.

Output: a sequence of token identifiers and an embedding matrix ready for processing by the generative AI model.

### Step 6:

The server generates draft information using the generative AI model.

Input: sequence of token identifiers and embedding matrix from Step 5, together with model parameters stored in memory.

The server feeds the embedding matrix into a transformer-based language model that includes multiple attention layers and feedforward layers.

The server executes matrix multiplications and non-linear activation functions on a processing unit, such as a graphics processing unit, to compute hidden states for each layer.

The server applies a softmax operation to the output layer to obtain probability distributions over possible next tokens and selects tokens either greedily or using sampling strategies. The server iteratively appends generated tokens until a termination condition is met, then decodes the token sequence back into text.

Output: draft information, including the generated business electronic message text and optional internal metadata such as token sequences and attention scores.

### Step 7:

The server performs sentence division processing on the draft information.

Input: generated draft text from Step 6.

The server scans the draft text for sentence delimiters and uses a rule set and statistical model to determine sentence boundaries, taking into account abbreviations and language-specific punctuation rules.

The server segments the draft text into individual sentence strings and records the character index ranges for each sentence.

Output: a list of sentence objects, each containing sentence text and positional information within the draft.

### Step 8:

The server performs language structure analysis on each sentence.

Input: sentence list from Step 7.

The server tokenizes each sentence into words or subwords and assigns part-of-speech tags using a tagging model or dictionary lookup.

The server constructs syntactic dependency graphs or phrase structure trees by applying a parsing algorithm to the token sequences.

The server stores part-of-speech tags and parse structures in data structures linked to their respective sentences.

Output: enriched sentence objects that include tokens, part-of-speech tags, and syntactic structures.

### Step 9:

The server detects and corrects spelling errors.

Input: enriched sentence objects from Step 8 and a lexicon of valid words.

The server compares each token to entries in the lexicon and identifies tokens that are not present or have low frequency.

The server computes edit distances between suspect tokens and candidate lexicon entries and scores candidates using a language model probability or n-gram statistics.

The server selects the best candidate for each spelling error and replaces the original token while recording the original-replacement mapping.

Output: updated sentence objects with corrected tokens and a list of spelling correction records.

### Step 10:

The server detects and corrects punctuation errors.

Input: sentence objects after spelling correction and a set of punctuation rules.

The server applies rule-based patterns to examine the positions of commas, periods, and other punctuation marks within each sentence.

The server identifies missing delimiters, superfluous marks, or misplaced punctuation based on syntactic boundaries and rule conditions.

The server inserts, removes, or moves punctuation characters as needed and updates sentence text and positional indices.

Output: sentence objects with corrected punctuation and a list of punctuation correction records.

### Step 11:

The server detects syntactic inconsistencies and applies syntactic corrections.

Input: sentence objects with corrected spelling and punctuation, and syntactic structures from Step 8.

The server evaluates dependency graphs or phrase trees against allowed templates and checks for agreement between subjects and verbs, correct use of conjunctions, and acceptable word order.

The server identifies inconsistent structures and selects correction strategies, such as swapping token positions or replacing conjunctions with preferred alternatives.

The server modifies token ordering or specific tokens and regenerates the sentence text while preserving alignment information.

Output: syntactically corrected sentence objects and syntactic correction records.

### Step 12:

The server reconstructs the corrected draft information from corrected sentences.

Input: lists of corrected sentence objects and correction records from Steps 9-11.

The server concatenates sentences in their original order, inserting appropriate whitespace and line breaks, to form a corrected draft text.

The server merges spelling, punctuation, and syntactic correction records into a single correction history linked to character ranges in the corrected draft.

Output: a corrected draft text and an integrated correction history.

### Step 13:

The server executes compliance analysis on the corrected draft information.

Input: corrected draft text from Step 12, rule information, and phrase information.

The server tokenizes the text and builds indices such as hash maps or prefix trees for efficient phrase lookup.

The server scans the token stream for sensitive phrases, prohibited expressions, or patterns defined by regular expressions.

The server optionally computes sentence embeddings and feeds them into a classifier to obtain compliance scores.

The server compares detected items and scores against thresholds defined in rule information to determine violations or potential violations.

Output: a list of compliance issues, each including a text span, issue type, and severity.

### Step 14:

The server generates warning information and correction candidate information. Input: compliance issues from Step 13 and the corrected draft text.

The server creates warning records that include character positions, rule identifiers, and descriptive messages.

The server constructs focused prompt sentences such as “Rewrite the following sentence to remove sensitive wording and maintain a professional tone: [sentence],” and sends these prompt sentences together with corresponding sentences to the generative AI model.

The server receives alternative sentences from the generative AI model, verifies that no prohibited phrases remain, and stores these alternatives as correction candidates.

Output: warning information associated with text spans and correction candidate information for each issue.

### Step 15:

The server assembles display information for the terminal.

Input: corrected draft text, correction history, warning information, and correction candidate information.

The server combines these elements into a structured description that specifies, for each text span, whether it was corrected and whether warnings or alternatives exist.

The server may compute visual attributes such as color codes or underline styles for different issue types.

The server serializes the assembled structure into a response message and prepares it for transmission.

Output: display information ready to be transmitted to the terminal.

### Step 16:

The terminal receives and renders the display information for the user.

Input: display information transmitted from the server.

The terminal parses the received structure and maps text spans to visual elements on a user interface.

The terminal draws the corrected draft text in a text view and applies highlighting, underlining, and icons to indicate corrections, warnings, and available alternatives.

The terminal activates input controls such as buttons, menus, and text fields to allow the user to edit text, select correction candidates, or request additional changes.

Output: a rendered draft view on the terminal display and an internal representation of the current document state.

### Step 17:

The user reviews the draft and optionally issues additional instruction input.

Input: rendered draft view and visible controls on the terminal.

The user reads the corrected text, inspects highlighted portions, and decides to accept, reject, or modify specific suggestions.

The user may select a correction candidate, directly edit the text, or enter a new instruction such as “Make the introduction more concise” in a text field.

The terminal captures these actions, updates the local document state, and packages additional instruction input and current context for the server.

Output: updated document content locally and additional instruction input to be sent to the server.

### Step 18:

The terminal transmits additional instruction input and context to the server. Input: additional instruction text, user selections, and current draft content.

The terminal builds a message that includes the latest draft text, locations of user edits, and new high-level instructions.

The terminal sends this message to the server over the network.

The server receives the message and decodes the content into updated structured information and meta information.

Output: updated structured information and additional instruction input stored in the server's memory.

### Step 19:

The server performs targeted regeneration based on additional instruction input.

Input: updated structured information, additional instruction input, and the current draft text. The server identifies which segments of the draft are affected by the new instructions, based on position markers and issue types.

The server constructs new detailed prompt sentences that reference the existing draft and describe the desired modifications, such as shortening or tone change, and limits generation to specified segments.

The server invokes the generative AI model with these prompt sentences and replacement segments, receives updated text, and integrates the updated segments into the existing draft while preserving unaffected portions.

Output: an updated draft text and updated correction and warning structures.

### Step 20:

The server returns updated display information to the terminal.

Input: updated draft text and associated annotations from Step 19.

The server reconstructs display information that reflects new text and any newly generated corrections or warnings.

The server transmits this updated display information to the terminal, where it is rendered in a similar manner as in Step 16.

Output: a refreshed draft view on the terminal showing the results of targeted regeneration. Step 21:

The user confirms a final version of the electronic message on the terminal.

Input: latest rendered draft view and associated controls.

The user inspects the updated draft, confirms that warnings are resolved or accepted, and triggers a confirmation operation, such as pressing a “Send” button.

The terminal collects the final subject, body, recipient addresses, and attachment information currently displayed.

Output: finalized electronic message information prepared within the terminal. Step 22:

The terminal transmits the finalized electronic message information to the server. Input: finalized electronic message information, including address information, subject information, body text, and attachment information.

The terminal serializes this information into a message and sends it to the server. The server receives and decodes the message and places the values into corresponding fields in a message object.

Output: a populated message object stored on the server side.

### Step 23:

The server validates the finalized electronic message information.

Input: message object with address information, subject information, and attachment information.

The server checks each address against syntax patterns and may perform domain lookups for verification.

The server verifies that the subject length and message size comply with configured constraints and that attachment sizes and types meet defined policies.

The server aggregates validation results and determines whether the message is transmittable or whether errors exist.

Output: a validation result, including error codes and messages if applicable.

### Step 24:

The server performs transmission preparation and message formatting.

Input: validated message object and validation result indicating that transmission is allowed. The server formats header fields, encodes the message body, and attaches binary data as necessary to create a protocol-compliant message structure.

The server sets fields such as From, To, Subject, and encodes content according to the transmission protocol requirements.

Output: a fully formatted electronic message ready for transmission to a message transfer device.

### Step 25:

The server transmits the electronic message and records transmission status.

Input: formatted electronic message from Step 24.

The server establishes a network connection to a message transfer device and transmits the message according to the transmission protocol.

The server receives acknowledgment codes from the message transfer device and interprets these codes as success or failure status.

The server writes a log entry containing the status, timestamps, and identifiers into persistent storage and sends a summary response back to the terminal.

Output: a recorded transmission status on the server and a delivery status notification visible to the user on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for generating work instructions in operational environments, such as logistics or industrial facilities, typically rely on static templates, manually authored documents, or simple rule-based text expansion. These systems often require a human operator to draft, edit, and verify the entirety of the instruction text. As a result, the quality and consistency of the instructions depend heavily on the individual skill of the operator, and substantial time and effort are expended on routine authoring, proofreading, and compliance checking tasks.

Furthermore, when natural language generation techniques are applied in a naive manner, for example by directly using a language model to produce an instruction document, the generated text may contain grammatical errors, ambiguities, or omissions in safety-related content. In safety-critical operations, such omissions can translate into non-compliance with internal policies or external regulations, and can degrade operational safety. Existing systems generally do not tightly integrate language generation, grammar checking, and compliance enforcement in a unified processing pipeline, nor do they capture the operator's intent and operational context in a structured way that can be fed back to a generative AI model as an effective prompt sentence.

In addition, prior systems tend to treat the user interface merely as a passive display for generated text, without positioning it as an active stage in a closed-loop process where user feedback and edits are systematically captured, structured, and utilized to improve subsequent generations. This leads to repeated manual corrections, redundant work, and an inability to continuously refine the underlying models or prompt construction strategies. The lack of a coordinated mechanism that connects user input, generative AI model prompting, grammar and compliance post-processing, and final distribution to worker terminals also results in fragmented system architectures and inefficiencies in implementation and maintenance. Accordingly, there is a need for an improved computer-based system that: (i) programmatically converts concise user instructions into structured prompt sentences appropriate for a generative AI model; (ii) automatically organizes the model's free-form natural language output into a machine-structured work instruction document; (iii) applies integrated grammar and compliance processing to the generated document; and (iv) supports user review and real-time correction through a user interface, followed by automated distribution to worker devices. Such a system should improve the functioning of the computer itself in the context of instruction generation by orchestrating multiple specialized processing stages on a processor, thereby reducing manual workload, increasing consistency, and enabling safe and compliant deployment of generative AI in operational environments.

The specific processing by the specific processing unit 290 of the data processing device 12 in Application Example 1 is realized by the following means.

The present invention provides a server comprising a processor configured to receive, via an input interface, operation instructions or objectives from a user, construct the received instructions as structured prompt sentences including attribute information such as operation type, priority, and operation location, and supply the prompt sentences together with related operation data to a generative AI model; to receive natural language text output by the generative AI model in response to the prompt sentences, automatically classify the natural language text into predefined items including operation objective, operation steps, required resources, and safety cautions, and store the classified items as a draft work instruction document; to perform grammar check processing on the draft work instruction document by analyzing sentences, detecting errors in word form, punctuation, and sentence structure, and automatically correcting the errors to obtain a grammatically formatted work instruction document; to perform compliance confirmation processing by evaluating the grammatically formatted work instruction document against stored compliance rules including safety standards and operation procedures, detecting presence or absence of predetermined keywords or phrases, determining whether the document corresponds to conditions such as work at a height or handling of harmful substances, and in response automatically supplementing missing safety instructions or inserting template sentences relating to protective measures so that the work instruction document conforms to the compliance rules; to perform user interface processing by causing the work instruction document confirmed in the compliance confirmation processing to be displayed on a display interface, receiving, from the user, confirmation of the work instruction document and additional or corrective input including work deadlines, responsible personnel information, and caution information, and updating the work instruction document based on the received input; and to perform distribution preparation processing by determining target workers and distribution media for the updated work instruction document, generating distribution data including electronic terminal data or print data corresponding to the updated work instruction document, and transmitting the distribution data to information processing apparatuses used by the target workers. This enables a coordinated, processor-implemented workflow that programmatically transforms concise user instructions into structured, grammatically correct, and compliance-checked work instruction documents using a generative AI model, reduces manual drafting and verification burdens, improves consistency and safety of the generated instructions, and enhances the functioning of the computer system in generating, managing, and distributing operational work instructions.

The term “processor” refers to one or more hardware-based computation units, such as a central processing unit or other programmable circuitry, configured to execute instructions and perform the processing operations described in the present disclosure. The term “input interface” refers to a hardware and software combination, such as a graphical user interface, application programming interface, or communication port, that enables a user or an external system to provide operation instructions, objectives, or related data to the processor.

The term “operation instruction” refers to information indicating a task, work content, or operational objective to be performed in an environment such as a facility, site, or process, and includes concise text entered by a user that serves as a basis for generating a work instruction document.

The term “objective” refers to information specifying a purpose, goal, or intended outcome of an operation, which is used by the processor to guide generation of a work instruction document.

The term “prompt sentence” refers to structured text constructed from an operation instruction and associated attributes, which is supplied as an input to a generative AI model to cause the model to generate natural language text corresponding to a work instruction document. The term “generative AI model” refers to a machine learning model, such as a language model trained on text data, that generates natural language output in response to input text including a prompt sentence.

The term “related operation data” refers to data associated with an operation, including but not limited to item lists, locations, schedules, resource information, and configuration data, which is used together with a prompt sentence to generate a work instruction document. The term “work instruction document” refers to a structured set of natural language expressions that describe one or more operations to be carried out, including at least an operation objective, operation steps, required resources, and safety-related information. The term “draft work instruction document” refers to an initial version of a work instruction document generated automatically by the processor based on output from a generative AI model before grammar checking, compliance confirmation, and user correction are fully completed.

The term “natural language text” refers to text expressed in a human language, such as a spoken or written language, that is understandable by a human operator without machine-specific coding.

The term “natural language processing technique” refers to a computational technique for processing natural language text, including but not limited to parsing, tokenization, classification, and generation, executed by the processor.

The term “grammar check processing” refers to processing performed by the processor to analyze sentences of a work instruction document, detect errors in word form, punctuation, and sentence structure, and automatically correct such errors to improve grammatical correctness.

The term “compliance rules” refers to a collection of machine-readable criteria, conditions, or patterns that represent safety standards, operation procedures, policies, or regulations to be applied to a work instruction document.

The term “safety standards” refers to rules or guidelines specifying required protective measures or procedures for preventing injury, damage, or unsafe conditions during execution of an operation.

The term “operation procedures” refers to rules, workflows, or steps that define how operations shall be performed in a facility or process, including sequences of actions, constraints, and verification actions.

The term “compliance confirmation processing” refers to processing performed by the processor to evaluate a work instruction document against compliance rules, detect presence or absence of predetermined keywords or phrases, determine whether specified conditions are satisfied, and modify the document so that it conforms to the compliance rules.

The term “predetermined keyword or phrase” refers to a word or expression registered in association with a compliance rule, used by the processor to detect relevant conditions in a work instruction document.

The term “protective measure” refers to an action or requirement intended to reduce risk in an operation, including, for example, wearing protective equipment, using safety devices, or following a specified safety procedure.

The term “template sentence” refers to pre-defined text stored in association with a particular condition or rule, which the processor can insert into a work instruction document to express a protective measure or other standardized content.

The term “operation height” refers to a condition representing a vertical position at which an operation is performed, used to determine whether the operation is considered work at a height exceeding a predetermined level.

The term “harmful substance” refers to any material, chemical, or object that may pose a risk to health, safety, or environment when handled, and that requires special handling instructions or protective measures.

The term “user interface processing” refers to processing performed by the processor to control display of a work instruction document, receive user confirmation and edits, and update the document based on user input.

The term “display interface” refers to a combination of hardware and software that presents information, including a work instruction document, to a user, and that allows the user to input modifications or confirmations.

The term “work deadline” refers to information indicating a time or period by which an operation described in a work instruction document should be completed.

The term “responsible personnel information” refers to data identifying one or more persons or roles assigned to perform or supervise an operation described in a work instruction document.

The term “caution information” refers to supplemental statements that warn of risks, emphasize important points, or specify conditions to be observed during execution of an operation.

The term “distribution preparation processing” refers to processing performed by the processor to determine target workers and distribution media for a work instruction document, generate distribution data formats, and cause transmission or output of the work instruction document.

The term “target worker” refers to a person or role designated to receive and execute, or manage execution of, an operation described in a work instruction document.

The term “distribution media” refers to a channel or format through which a work instruction document is provided to a target worker, including, for example, electronic terminal data or print data.

The term “electronic terminal data” refers to digital data formatted for display or processing on an information processing apparatus, such as a handheld device, workstation, or other electronic terminal.

The term “print data” refers to formatted data suitable for output by a printing apparatus to produce a physical copy of a work instruction document.

The term “information processing apparatus” refers to a device including a processor and memory, such as a terminal, workstation, or server, configured to receive, store, and present or process a work instruction document.

In one embodiment, a server, one or more terminals, and a user cooperate to implement the claimed system in a computing environment including a network. The server is implemented by one or more information processing devices, each including at least one processor, a main memory, a non-volatile storage device, and a network interface. The terminals are implemented by portable or stationary computing devices, such as handheld terminals, tablets, or workstations, each including a display, an input device, and a wireless or wired communication interface.

The server executes an operating system such as a general-purpose server operating system, and application software implemented, for example, using a web framework. The server further executes a natural language processing stack including a generative AI model implemented as a neural network, such as a transformer-based language model trained using a deep learning framework. The server also executes auxiliary components including a grammar checking engine, a compliance rule engine, and a distribution manager. The server stores data in a relational database management system such as a general-purpose DBMS. The terminal executes a client application, such as a web browser or native application, that communicates with the server via a network using a protocol such as HTTPS. The terminal displays user interfaces generated by the server and sends user inputs back to the server. The user operates the terminal to enter operation instructions and to review and correct work instruction documents.

In one configuration, the server stores in the database a table for user instructions, a table for prompt sentences, a table for generated work instruction documents, and a table for compliance rules. Each user instruction record includes fields such as an instruction identifier, user identifier, free-text instruction, language code, timestamp, and optional metadata. Each prompt sentence record includes a reference to the corresponding instruction, an attribute set including an operation type, a priority level, and an operation location, and the generated prompt sentence text. Each work instruction document record includes structured fields such as a title, an operation objective, a sequence of operation steps, a list of required resources, and a set of safety cautions, as well as flags indicating grammar check status and compliance confirmation status.

The server uses the generative AI model to transform a prompt sentence into a draft work instruction document. The generative AI model is implemented as a multi-layer transformer network including an embedding layer, a plurality of self-attention layers, and a feed-forward output layer. The server loads model parameters into memory from a model storage. The model is trained offline using a corpus of domain-specific texts, such as operation manuals, safety guidelines, and historical work instructions. During training, the server (or a training system) applies a supervised or self-supervised learning procedure that minimizes a loss function, such as a cross-entropy loss between predicted tokens and ground-truth tokens. The server updates model weights using an optimization algorithm such as stochastic gradient descent with adaptive moment estimation. In some embodiments, the server performs fine-tuning of the generative AI model using a dataset of previously approved, grammar-checked, and compliance-confirmed work instruction documents, thereby biasing the model toward output formats and vocabularies suitable for work instructions.

The server constructs a prompt sentence by combining a raw user instruction with attribute information. For example, the user may input on the terminal one of the following operation instructions:

“Pick products for the next shipment.”

“Perform inventory counting.”

“Carry out product packing work.”

The server stores the raw text and then assigns attribute information based on rule-based classification or machine learning classification. For instance, the server may classify “Pick products for the next shipment.” as an operation type “picking,” priority “high,” and operation location “shipping zone.” The server then constructs a prompt sentence such as:

“You are a logistics operations assistant. Based on the following request, generate a detailed work instruction for warehouse workers. Request: ‘Pick products for the next shipment.’ Include step-by-step actions, safety notes, and required data fields.”

The server stores the constructed prompt sentence in the database and then supplies the prompt sentence to the generative AI model as a sequence of tokens. The server converts the prompt sentence into token identifiers using a tokenizer associated with the model, and passes the token sequence to the model's input layer. The generative AI model produces a sequence of output token probabilities at each decoding step, and the server selects tokens using a decoding strategy such as greedy decoding or beam search, thereby generating natural language text.

The server then converts the generated token sequence back into text. The generated text typically contains multiple logical sections. The server parses the text using section markers, heading detection heuristics, and pattern-based parsing rules. For instance, the generative AI model may output:

“Title: Picking Instructions for Next Shipment Objective: Pick all products required for the next shipment.

Step 1: Check the shipment order list in the system.

Step 2: Move to the shelves listed below and pick the required quantities.

Step 3: Place fragile items in separate bins and attach ‘Handle with Care’ labels.

Safety Note: Always wear safety shoes and gloves during picking operations.”

The server analyzes the positions of colon characters and standard section labels such as “Title”, “Objective”, “Step”, and “Safety Note” to segment the text into corresponding fields. The server then stores each segment in the work instruction document record as structured data. This structuring step reduces ambiguity that would otherwise arise from free-form natural language and allows subsequent modules, such as the grammar check engine and the compliance rule engine, to operate on clearly defined fields.

The server performs grammar checking using a grammar checking engine, which may be implemented as a hybrid of rule-based parsing and neural language modeling. The server loads grammatical rules and dictionaries into memory and applies syntactic parsing to each sentence. The server identifies mismatches in subject-verb agreement, incorrect word forms, misplaced punctuation, and sentence fragments. The server then corrects these issues by selecting alternative tokens or by reordering phrases. In some embodiments, the server uses a secondary language model configured for correction of grammatical errors, with a smaller architecture than the generative AI model, trained specifically on error-corrected sentence pairs. The server passes each sentence to the correction model and receives a corrected version. The server compares the original sentence and the corrected sentence, and, when a difference is detected, replaces the original sentence with the corrected sentence in the work instruction document.

The server performs compliance confirmation using a rule engine. The server stores compliance rules as patterns combining keywords, thresholds, and actions. For example, a rule may specify that if a work instruction document contains expressions indicating work at a height above a certain threshold, then the document must include safety sentences about wearing a safety belt. Another rule may specify that if the document contains words related to chemical substances, then the document must include protective equipment requirements. The server uses keyword matching, part-of-speech tagging, and semantic similarity measures to detect whether the document satisfies the conditions of a rule. For instance, the server may detect terms such as “upper rack,” “ladder,” or “over 2 meters,” and map them to a semantic category “height-related.” The server then determines that the height-related condition is met and checks whether the document includes any sentence containing tokens indicating “safety belt” or equivalent terms. When the safety belt information is missing, the server inserts a template sentence, such as:

“When working at heights above 2 meters, always wear a safety belt and follow fall-prevention procedures.”

The server stores this template in a template repository, and fills variable parts according to configuration, such as the exact height threshold or specific device names. Similarly, when the server detects expressions related to chemical substances, the server inserts a template such as:

“When handling chemical substances, wear appropriate protective equipment including gloves, goggles, and a mask.”

By performing these insertions automatically and consistently, the server reduces the likelihood of human omission and ensures that generated instructions adhere to defined compliance rules.

The server generates the user interface displayed on the terminal by preparing a representation of the work instruction document suitable for interactive editing. The terminal receives an interface description via the network and renders input fields corresponding to the title, objective, steps, resource lists, and safety notes. The user reads the displayed content and may modify text segments directly. For example, the user may change a generic time statement into a specific deadline, such as replacing “by the end of the day” with “by 3:00 p.m. today,” or adding “This task is assigned to Worker ID W123 and W124.” The terminal sends edit operations back to the server, which applies the changes to the structured work instruction document. Because the document is stored as structured fields rather than as a flat text blob, the server applies changes to localized fields without corrupting the overall structure. This improves data integrity and makes subsequent retrieval and analysis more efficient. The server prepares distribution data after user confirmation. The server selects target workers or worker groups using a mapping table stored in the database, where work types or locations are mapped to worker identifiers and terminal identifiers. The server then generates electronic terminal data for each terminal type. For example, for a handheld device with limited screen size, the server formats the work instruction document into a compact layout, collapsing detailed explanation sections into collapsible panels and emphasizing the most critical steps and safety notes. The server additionally generates print data for environments in which paper instructions are used. The server uses a document rendering engine to convert the structured fields into a page layout and then into a printer-ready data format. The server then sends the electronic terminal data via a push message or pull API, and sends print data to a printer control subsystem. The terminal receives the electronic data, stores it locally, and renders it on the display, enabling a worker to access instructions even when temporarily disconnected from the network, thereby reducing communication load and increasing system robustness. This architecture results in a technical improvement to computer functionality beyond mere automation of human drafting. By constructing structured prompt sentences that incorporate attribute information and by structuring the generative AI model output into discrete fields, the server reduces the need to process undifferentiated free-form text and enables more efficient downstream processing by grammar and compliance modules. The use of a transformer-based generative AI model fine-tuned on approved work instructions improves the accuracy and domain conformity of the generated text, which in turn decreases the number of corrections needed by the grammar checking engine and by users. The grammar checking engine and compliance rule engine operate on structured data, allowing the server to execute targeted checks rather than scanning entire text strings repeatedly, thereby reducing computation time and memory usage.

Furthermore, the system provides a closed-loop mechanism in which user edits are captured and can be used, in alternative embodiments, to refine the generative AI model or to adjust rule parameters. For example, the server may record which model-generated sentences are frequently edited by users and may use this information to augment training data or to adjust decoding parameters for future generations. The server can compute statistics such as edit distance between generated and final text, and may, in another embodiment, optimize model parameters or prompt templates to minimize such distances. This feedback mechanism allows the system to continuously improve generation quality and reduces long-term computational cost, since improved initial outputs require fewer expensive post-processing operations. The system also achieves technical advantages in terms of data management. By storing instructions in a structured format with explicit fields for safety content, the server can index and query these fields independently. This enables faster retrieval of instructions meeting certain criteria, such as all instructions that include chemical handling or work at height. Compared to flat text storage, this structure allows for index-based queries rather than full-text scans, reducing input/output load and improving query latency. When the server distributes instructions to terminal devices, it sends only relevant fields or compressed representations, thereby reducing network bandwidth consumption.

In another embodiment, the server employs different neural network architectures for different languages or domains. For instance, a first generative AI model with a certain number of layers and parameters may be used for one language, while a second, more compact model may be used for another. The server selects the model dynamically based on language code stored with the user instruction. The server may also apply knowledge distillation techniques during training, where a larger teacher model is used to train a smaller student model that can be deployed on resource-constrained servers. This architecture improves computational efficiency and scalability.

The server may also implement specific data augmentation strategies during model training. For example, the server may generate paraphrases of instruction sentences and synthetic safety scenarios to increase robustness of the model to input variation. The server may use back-translation, synonym substitution, or template-based augmentation to create additional training samples. The server computes loss functions not only on next-token prediction but also on structural markers, such as heading boundaries and step identifiers, to encourage the model to output text that is easier to structure into document fields. This improves the downstream structuring accuracy and reduces the need for corrective parsing.

The terminal, in some embodiments, caches frequently used templates and portions of the interface so that the server can send only delta updates. This reduces communication overhead and improves response time. The user benefits from faster display updates and more responsive editing operations, which is a technical improvement in the functioning of the terminal application.

By combining these elements, the system provides a specific, technically implemented pipeline that uses a generative AI model not as a generic text generator but as a component within a structured document generation, verification, and distribution framework. The server, terminal, and user cooperate under defined protocols and data structures so that the system achieves improved processing speed, improved accuracy of instructions, reduced human error, and reduced network and computational load, thereby improving the overall computer technology used for generating and managing work instruction documents.

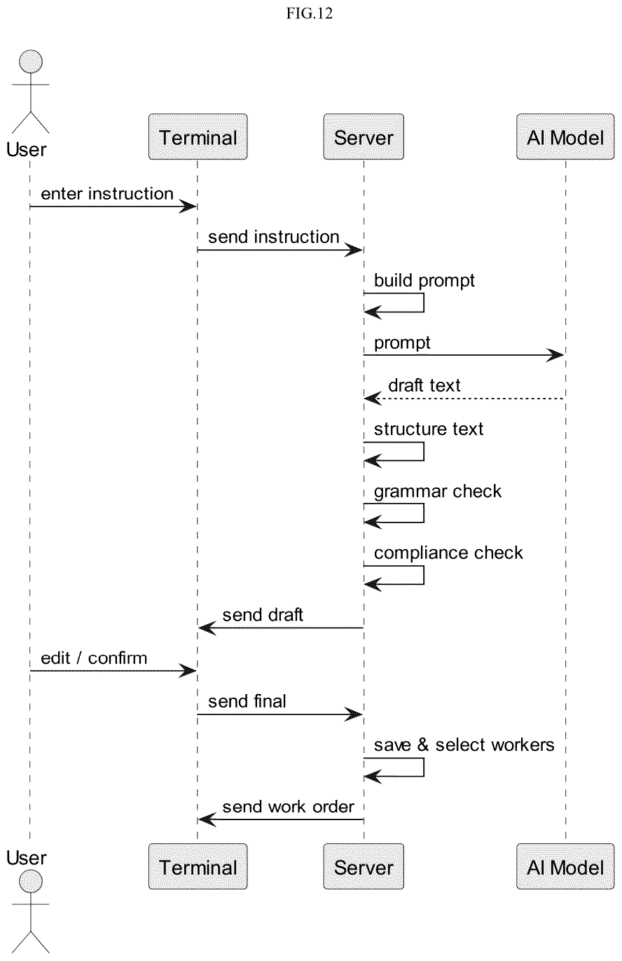

The following describes the processing flow using FIG. 12.

### Step 1:

User operates the terminal and opens a work instruction creation screen.

User inputs an operation instruction as free text (for example, “Pick products for the next shipment.”, “Perform inventory counting.”, or “Carry out product packing work.”) and optionally selects items such as operation type, target area, and urgency from dropdown lists. Terminal receives the user's input as raw text and selected attributes, combines them into an input message, and transmits the message to the server via a network using a protocol such as HTTPS.

The input to this step is the user's free-text instruction and selected options on the terminal, and the output of this step is a structured request message containing the instruction text and attribute values transmitted to the server.

### Step 2:

Server receives the structured request message from the terminal and parses it into fields including user identifier, raw instruction text, selected operation type, selected location, and priority.

Server performs data processing by normalizing the text (for example, lowercasing where appropriate, trimming whitespace, and validating character encoding) and mapping selected items to internal codes using lookup tables stored in a database.

Server then constructs a prompt sentence for a generative AI model by combining the normalized instruction text with the internal codes and fixed template phrases. For example, based on the input “Pick products for the next shipment.” and operation type “picking”, the server generates:

“You are a logistics operations assistant. Based on the following request, generate a detailed work instruction for warehouse workers. Request: ‘Pick products for the next shipment.’ Include step-by-step actions, safety notes, and required data fields.”

The input to this step is the structured request from the terminal, and the output of this step is a prompt sentence and associated attribute data stored in memory and optionally in the database.

### Step 3:

Server retrieves related operation data from a database, such as lists of items, shelf locations, and existing safety rules linked to the operation type and location.

Server merges the prompt sentence with the retrieved operation data by assembling a model input object that includes both the textual prompt and contextual metadata encoded as additional tokens or appended text segments.

Server tokenizes the combined text using a tokenizer associated with the generative AI model, converting characters and words into numerical token identifiers.

The input to this step is the prompt sentence and related operation records, and the output of this step is a tokenized representation and context data ready for input to the generative AI model.

### Step 4:

Server supplies the tokenized prompt and context to the generative AI model executed on a processing unit, such as a GPU-accelerated neural network engine.

Server executes the forward pass of a transformer-based language model by propagating the token embeddings through multiple self-attention layers and feed-forward layers, computing probability distributions over possible next tokens at each time step.

Server applies a decoding algorithm, such as greedy decoding or beam search, to select actual output tokens from the probability distributions, and concatenates the selected tokens to form a generated text sequence.

Server converts the sequence of output tokens back into natural language text using the tokenizer's decoding function.

The input to this step is the tokenized prompt and context, and the output of this step is a free-form draft text describing a work instruction.

### Step 5:

Server analyzes the generated free-form draft text to extract structural elements.

Server scans the text for delimiters such as “Title:”, “Objective:”, “Step 1:”, and “Safety Note:” by performing pattern matching and searching for known labels.

Server splits the text at these delimiters and assigns each segment to a corresponding field (for example, title field, objective field, ordered list of steps, safety notes list).

Server stores the segmented fields as a structured draft work instruction record in the database, including references to the original prompt and user instruction.

The input to this step is the plain draft text from the generative AI model, and the output of this step is a structured draft work instruction document consisting of multiple labeled fields.

### Step 6:

Server performs grammar check processing on each field of the draft work instruction. Server passes sentences from the title, objective, steps, and safety sections to a grammar checking engine that includes syntactic parsing rules and/or a neural correction model. Server analyzes each sentence for errors in word form, punctuation, and syntax by computing language scores, checking part-of-speech sequences, and comparing candidate corrections suggested by the correction model.

Server replaces incorrect segments with corrected text and recombines the corrected sentences into updated field values.

The input to this step is the structured draft work instruction with uncorrected text, and the output of this step is a grammatically corrected work instruction document with the same structure but improved sentence quality.

### Step 7:

Server executes compliance confirmation processing using a rule engine and the corrected work instruction document.

Server scans the fields for predetermined keywords and phrases (for example, terms related to work height, chemical handling, lifting equipment, or protective equipment) using keyword matching and semantic category mapping.

Server evaluates detected terms against stored compliance rules that specify conditions (such as “height>2 m” or “chemical substance involved”) and required safety content.

When a rule condition is satisfied and required safety text is missing, server inserts corresponding template sentences into the safety section or appends them to relevant steps, adjusting variable parts such as height values or names of protective equipment. The input to this step is the grammatically corrected work instruction document, and the output of this step is a compliance-confirmed work instruction document that contains automatically inserted or adjusted safety and procedure statements.

### Step 8:

Server transmits the compliance-confirmed work instruction document and metadata to the terminal for user review.

Terminal receives the document as structured data and renders it into an editable form on the display, showing fields such as title, objective, ordered steps, resource requirements, and safety notes.

User reads the displayed content, verifies that the operations match real-world requirements, and may edit text in any field, for example updating the deadline, specifying particular worker identifiers, or adding location-specific cautions.

Terminal records user edits as change operations and sends the updated content back to the server as a revised work instruction message.

The input to this step is the compliance-confirmed work instruction document provided by the server, and the output of this step is a user-corrected version of the work instruction document stored on the server.

### Step 9:

Server receives the user-corrected work instruction document, validates the edits against structural constraints (for example, ensuring that step numbers remain in sequence and required fields are not left empty), and updates the corresponding record in the database. Server marks the document state as final or approved and assigns a version identifier and timestamp to the record.

Server may optionally run a lightweight re-check for critical compliance rules on edited sections to confirm that essential safety statements remain present after user edits.

The input to this step is the edited work instruction document received from the terminal, and the output of this step is a finalized, versioned work instruction document ready for distribution.

### Step 10:

Server determines distribution targets by querying a mapping table that links operation types, locations, or responsible personnel to specific worker identifiers and associated terminal identifiers.

Server generates distribution data in formats suitable for each terminal type, including a compact layout for handheld terminals and a full-detail layout for larger displays or print output.

Server sends electronic terminal data via push messaging or an API response to the identified terminals, and optionally sends print data to a printing subsystem for paper output. Terminal receives the distribution data, stores it locally, and displays the work instruction to the assigned worker, who can then follow the structured steps and safety notes during real-world operations.

The input to this step is the finalized work instruction document and worker mapping data, and the output of this step is delivered work instructions on worker terminals and/or printed media accessible in the operational environment.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional business electronic mail drafting systems, natural language generation, grammar checking, and compliance checking are often implemented as separate and static components. A typical system merely takes a user's instruction, invokes a language model or template engine to produce a draft, applies a generic grammar checker, and optionally scans for prohibited terms. Such systems do not take into account dynamic behavioral signals collected at the time of text entry, such as typing speed or correction frequency, and therefore cannot infer the user's emotional state at the moment of drafting. As a consequence, when a user is in an emotional state such as anger or anxiety, the system may generate or allow the transmission of drafts containing confrontational tone or borderline-compliant expressions, even if grammar and basic compliance checks are satisfied. From a computer-technology standpoint, existing architectures lack an integrated control loop that uses runtime interaction data as a first-class input to downstream natural language processing pipelines and transmission control. Emotion analysis, where it exists, is typically an offline analytic function and is not tightly coupled to the generative AI model, the grammar analysis engine, the compliance component, and the transmission scheduler in a unified processing flow. This disjoint design leads to several technical problems: (i) processing modules cannot adapt their behavior based on the user's real-time emotional state; (ii) there is no mechanism to automatically strengthen compliance and tone-moderation rules when high-risk emotional conditions are detected; and (iii) transmission timing is decoupled from the actual risk level embedded in the text and the user's state, resulting in immediate sending of high-risk messages without a cooling-off mechanism.

Furthermore, conventional systems treat the draft text as a static artifact after initial generation. They do not provide a feedback-driven regeneration mechanism in which the processor re-constructs an internal prompt sentence for a generative AI model in response to user interaction (for example, a tone-relaxation request) and re-applies grammar and compliance processing in a coordinated manner. As a result, the underlying computing resources are not orchestrated to dynamically refine the draft in stages according to the user's state and the evolving content, which leads to inefficiencies, inconsistent processing quality, and residual compliance risks.

Accordingly, there is a need for a computer-implemented system and processing architecture in which a processor: (i) acquires low-level operation information together with a prompt sentence, (ii) estimates an emotion state of the user, (iii) generates and refines an internal prompt sentence for a generative AI model based on the emotion state, (iv) coordinates grammar analysis and compliance checking with emotion-aware tone adjustment, and (v) controls transmission timing based on the same emotion state and content analysis. Such a system should improve the technical operation of the overall mail-generation pipeline by adaptively re-configuring model parameters, rule thresholds, and scheduling decisions in response to real-time user interaction data, thereby reducing the likelihood that emotionally charged, non-compliant emails are generated and transmitted by the computing system.

The specific processing by the specific processing unit 290 of the data processing device 12 in Example 2 is realized by the following means.

The present invention provides a server comprising a processor and a memory storing instructions which, when executed by the processor, cause the processor to acquire operation information including at least an input start time, an input end time, a character count, an input speed, and a correction operation count, together with a prompt sentence input by a user; generate emotion state data indicating an emotion state of the user by performing emotion analysis using a machine learning model and threshold determination based on the operation information and the prompt sentence; generate an internal prompt sentence for input to a generative AI model by embedding the prompt sentence, the emotion state data, and tone designation information into predetermined positions of template text; input the internal prompt sentence to the generative AI model and automatically generate a draft document including a subject and a body of a business electronic mail by performing natural language generation processing; input body text of the draft document to a grammar analysis engine and automatically correct grammar errors, spelling errors, and punctuation errors in the body text based on error information obtained by syntactic analysis and spell-checking; when the emotion state data indicates anger or anxiety exceeding a predetermined threshold, detect emotional expressions in the body text by collating the body text with dictionary data in which emotional emphasis expressions are registered, and generate correction proposals including moderate alternative expressions by performing reference to a substitution table or paraphrase generation processing using the generative AI model; perform morphological analysis and compliance dictionary collation on the body text to detect prohibited expressions, confidential-information-related expressions, and inappropriate expressions as compliance-violation candidate expressions, and generate, for each of the compliance-violation candidate expressions, a corresponding correction proposal and warning information; generate display data including the draft document, the emotion state data, the correction proposals for the emotional expressions, and the compliance-violation candidate expressions, and control a user interface to perform preview display of the draft document, presentation of the correction proposals, and reception of manual correction operations by the user; and perform format verification for destination information, the subject, and attachment information based on a transmission instruction and the emotion state data, and, when the emotion state exceeds a predetermined threshold, determine whether to perform immediate transmission of the business electronic mail or to perform reconfirmation after holding transmission for a predetermined time, and control electronic mail transmission processing based on the determination. This enables a computer-implemented mail-generation pipeline in which generative AI-based drafting, grammar checking, compliance checking, tone adjustment, and transmission scheduling are dynamically coordinated according to a real-time emotion state of the user, thereby improving the technical operation of the system by reducing high-risk transmissions, enforcing adaptive processing conditions, and enhancing robustness and reliability of business electronic mail generation and delivery.

The term “operation information” refers to dynamic data items associated with a user's text input operation, including at least an input start time, an input end time, a character count, an input speed, and a correction operation count, and optionally other metrics indicative of typing behavior.

The term “prompt sentence” refers to a natural-language instruction or description input by a user to specify a target and purpose of text generation by a generative AI model, including, for example, a brief statement of what kind of business electronic mail is to be created. The term “emotion state data” refers to structured data indicating a user's emotional condition inferred from a prompt sentence and operation information, including at least an emotion label such as anger, anxiety, or neutral, and optionally one or more numerical scores representing intensity of the emotion.

The term “machine learning model” refers to a computational model generated by training on data using a machine learning algorithm, such as a neural network, a support vector machine, or a statistical classifier, and configured to output emotion-related predictions based on text and/or numerical features.

The term “threshold determination processing” refers to processing in which numerical values derived from operation information and model outputs are compared with one or more predetermined threshold values to determine whether an emotion state satisfies a condition such as being above or below a risk level.

The term “tone designation information” refers to data indicating a desired stylistic tone of generated text, such as formal, neutral, or friendly, specified by a user or by default settings and used as a parameter in prompt construction and generation control.

The term “template text” refers to predefined text data containing one or more placeholders or insertion positions into which variable information such as a prompt sentence, emotion state data, and tone designation information can be embedded by string processing.

The term “internal prompt sentence” refers to a text string constructed by the server by embedding a user's prompt sentence, emotion state data, and tone designation information into template text, and used as an input instruction to a generative AI model to control generation behavior.

The term “generative AI model” refers to a machine-learned generative model, such as a large language model, that has been trained on large amounts of text data and is configured to generate natural-language tokens or sequences in response to a prompt.

The term “draft document” refers to a non-final, automatically generated candidate of a business electronic mail, including at least a subject text and a body text, which is subject to further grammar correction, compliance checking, and manual editing.

The term “business electronic mail” refers to an electronic message used for business or organizational purposes, such as communication, reporting, requesting, or notifying, and not primarily for personal or private correspondence.

The term “grammar analysis engine” refers to a software component configured to analyze natural-language text for grammatical structure, spelling correctness, and punctuation usage, and to output error information and, optionally, suggested corrections.

The term “error information” refers to data produced by the grammar analysis engine that specifies location, type, and optionally suggested corrections for detected issues such as grammar errors, spelling errors, and punctuation errors in a text.

The term “emotional emphasis expression” refers to a lexical item or phrase that linguistically indicates a heightened emotional attitude, such as strong anger or frustration, including intensified adjectives, adverbs, or idiomatic expressions that convey an escalated tone.

The term “dictionary data” refers to stored lexical and phrase data, typically in a structured format such as a table or list, used for matching against text in order to detect predefined tokens, including emotional emphasis expressions and compliance-related terms. The term “correction proposal” refers to an automatically generated or predefined alternative expression, rewrite, or modification suggestion that is intended to replace or modify a portion of text to improve tone, grammar, or compliance properties.

The term “substitution table” refers to a data structure that associates one or more original expressions with one or more alternative expressions, which can be used to replace detected segments of text with softer, more appropriate, or compliant wording.

The term “morphological analysis” refers to processing that segments a text into smaller linguistic units such as words or morphemes, optionally assigning part-of-speech or other linguistic tags, for use in downstream analysis such as compliance checking.

The term “compliance dictionary” refers to a stored set of lexical entries and patterns that define expressions related to compliance risks, such as prohibited terms, confidential-information indicators, or inappropriate wording, used to detect compliance-violation candidates.

The term “compliance-violation candidate expression” refers to a word, phrase, or segment of text that, based on matching with a compliance dictionary or rules, is determined to have a possibility of violating a policy, regulation, or organizational guideline.

The term “warning information” refers to explanatory data presented to a user that describes the reason why a detected expression is considered a compliance-violation candidate and optionally provides guidance for modification or removal.

The term “display data” refers to structured data generated by the server for presentation on a user interface, including at least draft document content, emotion state data, correction proposals, and compliance-violation candidate expressions, together with associated metadata. The term “user interface” refers to a visual or interactive presentation layer, such as a graphical user interface on a terminal, through which information is displayed to a user and input operations, including editing and command selections, are received.

The term “transmission instruction” refers to a user-initiated command, such as activation of a send operation on a terminal, requesting that the system transmit a draft document as a business electronic mail.

The term “format verification” refers to processing that checks whether structured data such as destination information, subject text, and attachment information satisfy predetermined syntactic or policy constraints, including address format patterns and length limitations.

The term “destination information” refers to electronic mail address data specifying at least one recipient of a business electronic mail, including addresses for primary recipients, carbon-copy recipients, or blind-carbon-copy recipients.

The term “attachment information” refers to metadata regarding files to be sent with an electronic mail, including at least file names, file types, and file sizes, which are subject to validation against permitted formats and size limits.

The term “transmission-hold control processing” refers to control logic that, based on emotion state data or other conditions, delays immediate sending of a business electronic mail, schedules a later time for reconfirmation, and triggers re-display and final confirmation before actual transmission.

The term “scheduler function” refers to a system or software component that manages timed execution of tasks, such as triggering re-preview display of a draft document or initiating a transmission operation after a predetermined time interval.

The term “tone-relaxation instruction” refers to a user command indicating that the user desires to make the language of a draft document less emotional or confrontational, prompting the system to perform tone adjustment using the generative AI model.

The term “re-analysis processing” refers to repeated application of at least one of grammar analysis and compliance checking to text that has been modified, for example by tone adjustment, to ensure that the updated text continues to meet grammatical and compliance criteria.

In one embodiment, a server cooperates with a terminal and a user to implement the claimed system. The server is realized as a general-purpose information processing apparatus including at least one multi-core central processing unit (CPU), a main memory, a non-volatile storage device such as a solid state drive, and a network interface. The server operates under a server operating system such as a general-purpose UNIX-like operating system or a server-grade operating system and executes an application framework such as a web application framework or an application server. The server further executes a database management component for storing configuration data, dictionaries, and logs.

The terminal is realized as an information processing apparatus such as a smartphone, a tablet, or a personal computer, and includes a processor, a display unit, an input device such as a keyboard or a touch panel, a memory, and a network interface such as a wireless communication module. The terminal operates under a general-purpose client operating system and executes a web browser or a native application. The terminal displays a user interface that allows the user to input a prompt sentence, tone designation information, destination information, and a subject of a business electronic mail.

The user operates the terminal to cause the terminal to display a mail generation screen. The terminal displays, on the display unit, a text input area for a prompt sentence, selection components for tone designation, input fields for destination information, and an input field for a subject. The user inputs a prompt sentence in natural language, such as: “Send a reminder for tomorrow's project meeting.”

“Create an apology email for the delivery delay.” “Send a progress report for the current project.”

“Prepare a complaint-handling email.”

“Create an apology email for a delivery delay.”

“Create a price negotiation request email.”

The terminal records operation information associated with the input operation. The terminal measures, using a system clock, an input start time when the user begins entering the prompt sentence and an input end time when the user completes the input. The terminal counts the number of characters entered into the prompt sentence field, and counts correction operations such as backspace key presses or character deletions based on input events from the operating system. The terminal computes an input speed by dividing the character count by the elapsed time between the start time and the end time. The terminal stores this operation information in a structured data object in the terminal's main memory.

The server receives, via the network interface, a request message from the terminal that includes the prompt sentence, the tone designation information, the destination information, and the operation information. The server deserializes the request message using a structured data parser, and stores each data item in memory as part of a request context. The server then executes a series of data processing operations and numerical computations according to the instructions stored in the memory.

The server performs emotion analysis by using a machine learning model that has been trained to predict emotion categories from text and numeric features. In one embodiment, the server stores, in the storage device, parameters of a neural network model comprising an input embedding layer, multiple transformer encoder layers, and a classification head. The server loads the parameters into the main memory and executes inference operations on the CPU or, in another embodiment, on a graphics processing unit (GPU) via a parallel computation library.

The server tokenizes the prompt sentence using a tokenizer component configured with a vocabulary. The server maps each token to an integer index and then to a dense vector representation via an embedding matrix stored in the model parameters. The server inputs the sequence of embeddings into the transformer encoder layers, each layer comprising multi-head self-attention sub-layers and position-wise feedforward sub-layers. The server performs matrix multiplications, attention-weight computations, nonlinear activation functions, and residual connections to compute a contextual representation of the sequence. The server then applies the classification head, which includes at least one fully connected layer and a softmax function, to obtain probability values for emotion categories such as anger, anxiety, and neutral.

The server further processes the operation information to derive numerical features such as normalized input speed and normalized correction ratio. The server compares these features with threshold values stored in configuration data and generates indicator values such as a high-speed input flag or a high-correction flag. The server concatenates or otherwise combines these indicator values with the output probabilities of the neural network and computes an emotion score using a weighted sum or rule-based logic. The server derives emotion state data including an emotion label, such as anger or anxiety, and associated intensity scores. The server stores the emotion state data in the request context.

The server generates an internal prompt sentence by embedding the prompt sentence, the tone designation information, and the emotion state data into template text. The server stores, in the storage device, template text that includes placeholders for the prompt sentence, the emotion label, and the tone designation. The server performs string operations in the memory to replace the placeholders with the corresponding values. For example, when the emotion label is anger and the tone designation is formal, the server constructs internal prompt text that includes explicit instructions such as “Even if the user is angry, generate a polite, calm, and recipient-considerate business email.”

The server then uses a generative AI model to generate a draft document based on the internal prompt sentence. In one embodiment, the generative AI model is a transformer-based language model that has been pre-trained on large volumes of text data using an auto-regressive language modeling objective. The server stores the model parameters and vocabulary in the storage device and loads them into memory for inference. The server encodes the internal prompt sentence into token indices and embedding vectors, and sequentially predicts the next token at each step by computing attention over previous tokens and outputting a probability distribution over the vocabulary. The server performs sampling or greedy decoding to obtain a sequence of tokens representing the generated text, and decodes the token sequence into a natural-language string. The server parses the generated string to separate a subject part and a body part of the business electronic mail, using pattern detection such as identifying a line starting with “Subject:” or applying regular expressions. The server thus forms a draft document including subject text and body text.

The server applies a grammar analysis engine to the body text of the draft document. The server invokes a software module that performs syntactic analysis and spelling checks. The grammar analysis engine tokenizes the text, identifies parts of speech, and constructs syntactic structures. The grammar analysis engine compares the text against language rules and a dictionary, and outputs error information that specifies positions and types of errors such as grammar errors, spelling errors, and punctuation errors. The server receives the error information and performs string replacement operations in the memory to correct the detected errors. This automatic correction reduces the need for repeated external processing and improves the consistency of the generated drafts.

When the emotion state data indicates anger or anxiety above a predetermined threshold, the server performs tone adjustment. The server stores dictionary data that associates emotional emphasis expressions with identifiers and categories indicating high emotional intensity. The server scans the body text of the draft document and identifies occurrences that match the registered expressions via string matching or pattern matching algorithms. The server then generates correction proposals for each detected emotional expression. In one embodiment, the server uses a substitution table that maps each emotional expression to one or more moderate alternative expressions. In another embodiment, the server constructs a short prompt sentence instructing the generative AI model to rewrite the detected phrase in a calmer and more professional manner. The server inputs this short prompt to the generative AI model, obtains paraphrased expressions, and stores them as candidate replacements. By using the generative AI model in combination with static dictionary data, the server can generate contextually appropriate alternative expressions that are not easily produced by human rule-based editing alone.

The server performs compliance checking using morphological analysis and a compliance dictionary. The server executes a morphological analysis program on the body text and produces a list of tokens and associated part-of-speech tags. The server compares these tokens and n-grams against compliance dictionary entries representing prohibited expressions, expressions indicating possible confidential information, and inappropriate expressions. The server may also apply additional rules that inspect combinations of tokens or specific patterns.

When a match is found, the server registers the corresponding segment as a compliance-violation candidate expression and retrieves a recommended alternative expression or a guideline message from the compliance dictionary or a rule set. The server constructs warning information describing why the segment constitutes a risk and what modification is advised. In states of high anger, the server activates stricter rules or uses lower thresholds to detect a wider range of expressions as candidates, thereby increasing robustness against high-risk content.

The server generates display data that integrates the draft document, the emotion state data, the correction proposals for emotional expressions, and the compliance-violation candidate expressions with corresponding warning information. The server serializes this display data into a structured format and transmits it to the terminal via the network interface. The terminal receives the display data and updates the user interface to present the subject, the body, and visual indicators such as underlines or highlights for segments associated with emotional or compliance issues. The terminal also displays control elements such as buttons or menu items allowing the user to apply correction proposals, request tone relaxation, or proceed to transmission.

The user reviews the draft document displayed on the terminal and may modify the text directly or apply suggested corrections. When the user selects a tone relaxation function, the terminal transmits an update request including a tone-relaxation instruction and the current body text to the server. The server receives this update request and constructs a new internal prompt sentence that instructs the generative AI model to rewrite the current body into a calm and considerate business email while preserving the factual content. The server runs the generative AI model again and obtains a rewritten body text. The server then applies the grammar analysis and compliance checking procedures once more to the rewritten text to ensure that the refined draft continues to satisfy linguistic and compliance criteria. This iterative regeneration and re-analysis flow, which is guided by the emotion state and explicit user instructions, implements a non-conventional, multi-stage text refinement process that improves both accuracy and consistency of the generated drafts.

The server controls the final transmission of the business electronic mail based on the emotion state data and the content analysis results. The server validates formats of destination information, such as email addresses, by applying regular expressions and policy rules stored in configuration data. The server checks that the subject length and attachment information, such as file types and sizes, satisfy predetermined constraints. The server then evaluates the emotion state at the time of a transmission instruction. When the intensity of anger or anxiety exceeds a predetermined threshold, the server determines that a cooling-off period is desirable. The server generates response data indicating options such as immediate transmission and reconfirmation after a predetermined time. The terminal displays these options, and the user selects a desired option. In a reconfirmation case, the server registers a task into a scheduler function that triggers re-preview display after the lapse of the predetermined time. This scheduling mechanism and controlled delay are executed by the server at the system level and are not feasible by manual human decision alone at comparable speed and consistency.

The server thus orchestrates multiple software modules-emotion analysis, generative AI model inference, grammar analysis, compliance checking, and scheduling-in a coordinated manner using shared data structures such as request contexts, token sequences, and annotation lists. Because the server adapts the processing pipeline to the real-time emotion state and statistical properties of the user's input, the server reduces unnecessary invocations of heavy processing and can allocate compute resources more efficiently. For example, the server intensifies compliance checks only when the emotion intensity is high, and avoids redundant tone adjustments when the emotion state is neutral and all compliance criteria are already satisfied. This dynamic control leads to improved processing throughput, reduced latency for low-risk drafts, and improved detection accuracy for high-risk drafts.

From a technical standpoint, the described system improves computer technology in several respects. The server uses operation information, such as typing speed and correction frequency, as additional features for emotion estimation, thereby improving the accuracy of emotion classification over purely text-based models. The server employs a specific network architecture (transformer-based neural network), a defined loss function (for example, cross-entropy), and a weight update algorithm (for example, stochastic gradient descent with adaptive learning rate) during training, and utilizes this trained model at inference time in combination with rule-based thresholds to define emotion state data. The server stores model parameters in optimized data structures and performs batched matrix operations on hardware accelerators when available, leading to higher computation efficiency.

Furthermore, the server integrates the emotion-aware draft generation and tone adjustment into the grammar and compliance engines by using annotated text structures. The server attaches metadata to character spans in the body text to mark emotional expressions and compliance-violation candidates, and the terminal uses these annotations to render highlights without separate parsing. This reduces redundant text scanning on the client side and lowers network traffic by transmitting a single integrated representation rather than multiple separate reports.

The server's architecture is different from a mere automation of human drafting work, because the server executes coordinated numerical algorithms, model inferences, string transformations, and scheduling decisions that are not performed by human operators in real-time. The server defines non-intuitive rules, such as conditionally modifying thresholds and generation constraints based on latent emotion scores, and implements a feedback loop between user interface events, emotion estimation, and generative model prompts. This feedback loop causes the generative AI model to be driven by system-level state variables rather than merely echoing user input. As a result, the system achieves improved accuracy in detecting risky drafts and improved robustness against impulsive transmissions, which are measurable technical effects in terms of reduced error rates, lower violation incidence, and improved utilization efficiency of computing resources.

In another embodiment, the server may employ different machine learning models for emotion analysis, such as a recurrent neural network or a convolutional network, and different generative AI architectures, such as encoder-decoder transformers. The server may also use alternative grammar analysis engines or compliance dictionaries according to language and domain. In each embodiment, the server maintains the same fundamental data flow: acquiring operation information and a prompt sentence, generating emotion state data, constructing an internal prompt sentence, generating and refining a draft document using a generative AI model, applying grammar and compliance processing, and controlling transmission timing based on the combined results. This modular yet tightly integrated architecture allows the system to adapt to different hardware platforms and software stacks while preserving the technical improvements afforded by emotion-aware, multi-stage automated drafting and transmission control.

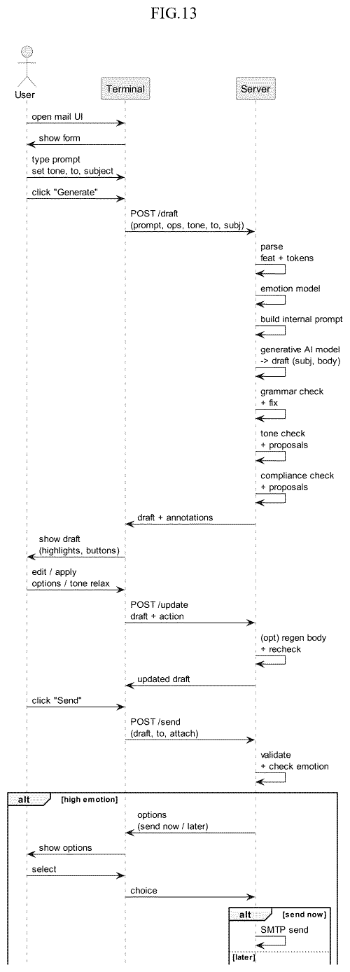

The following describes the processing flow using FIG. 13.

### Step 1:

The terminal displays a mail-generation user interface and initializes input logging. The terminal loads a mail-generation screen that includes a text field for a prompt sentence, selection controls for tone designation, input fields for destination information and subject, and a button for draft generation. The terminal initializes internal variables for logging operation information, such as input start time, input end time, character count, and correction operation count.

Input: No user input yet; initial UI configuration and default settings.

Processing: The terminal allocates data structures in memory for a prompt sentence, tone designation information, destination information, subject text, and operation information; the terminal binds event listeners to the text fields and buttons.

Output: A rendered mail-generation screen on the display and initialized in-memory structures ready to capture user operations.

### Step 2:

The user enters a prompt sentence and related mail parameters on the terminal. The user types a prompt sentence such as “Send a reminder for tomorrow's project meeting.” or “Create an apology email for the delivery delay.” into the prompt sentence field. The user selects a tone (for example, formal or friendly) from a selection control and may input destination information and a provisional subject. The terminal detects the moment when the user starts typing and records an input start time, and it detects when the user stops or moves focus and records an input end time.

Input: Keystroke events, selection events, and focus events generated by the terminal's operating system and UI framework.

Processing: The terminal increments character count on each character insertion, increments correction operation count when a backspace or delete operation is detected, and updates the current text of the prompt sentence, destination fields, and subject field in memory. The terminal computes an intermediate input duration as a difference between current time and input start time.

Output: Updated UI fields showing the prompt sentence, tone, destination information, and subject; operation information (start time, provisional end time, character count, correction operation count) maintained in terminal memory.

### Step 3:

The terminal finalizes operation information and constructs a draft-generation request. The user presses a draft-generation button on the terminal. The terminal sets the input end time to the current system clock value and computes the final input duration. The terminal computes an input speed as character count divided by duration and deduces any other derived metrics required for emotion analysis. The terminal then constructs a structured request object containing the prompt sentence, tone designation information, destination information, subject text, and operation information.

Input: Final contents of the UI fields (prompt sentence, tone, destination information, subject), logged start time, logged end time, character count, and correction operation count.

Processing: The terminal calculates numeric features such as input duration and input speed, packages text fields and numeric features into a structured object (for example, a key-value representation), and serializes the object into a format such as JSON using a serialization library.

Output: A serialized draft-generation request payload ready to be sent over the network.

### Step 4:

The terminal transmits the draft-generation request to the server.

The terminal opens an HTTP or HTTPS connection to a server endpoint and sends the serialized request payload in the body of a POST request. The terminal attaches headers such as content type and authentication if required.

Input: Serialized draft-generation request payload stored in terminal memory.

Processing: The terminal uses a network stack to encapsulate the payload into transport packets (for example, TCP segments) and forwards them to the server via the network interface. The terminal manages retries and timeouts according to protocol rules.

Output: A network transmission containing the draft-generation request that is delivered to the server.

### Step 5:

The server receives and parses the draft-generation request.

The server accepts the incoming network connection and passes the HTTP request to an application framework. The server reads the request body, identifies the content as serialized structured data, and deserializes it into internal variables.

Input: Serialized draft-generation request payload carried in the HTTP request body. Processing: The server uses a parser or library to convert the serialized payload into an in-memory structure; the server extracts the prompt sentence, tone designation information, destination information, subject text, and operation information (start time, end time, character count, correction operation count). The server stores these values in a request context object in main memory.

Output: An internal request context containing all extracted fields, available for subsequent processing on the server.

### Step 6:

The server computes numerical features from operation information and prepares emotion-analysis inputs.

The server calculates input duration as the difference between input end time and input start time, and calculates input speed as the ratio of character count to input duration. The server also calculates a correction ratio as the ratio of correction operation count to character count. Input: Start time, end time, character count, and correction operation count from the request context.

Processing: The server executes arithmetic operations (subtraction, division) to derive numeric features. The server optionally normalizes these features using scaling parameters stored in configuration data, such as mean and standard deviation values determined during model training. The server packages these numeric features into a feature vector to be combined with text-based features for emotion analysis.

Output: A numerical feature vector representing the user's typing behavior, stored in the request context.

### Step 7:

The server tokenizes the prompt sentence and encodes text features for emotion analysis. The server passes the prompt sentence through a tokenizer that segments the text into tokens (for example, sub-word units). The server maps each token to an integer identifier using a vocabulary table and then to an embedding vector using an embedding matrix.

Input: Prompt sentence string from the request context.

Processing: The server executes tokenization algorithms such as byte-pair encoding or wordpiece segmentation, performs table lookups to obtain token IDs, and performs matrix multiplications to obtain embedding vectors for each token. The server constructs a sequence of embeddings ready to be processed by the emotion analysis model.

Output: A token sequence and an embedding sequence representing the prompt sentence, stored in memory as input to the emotion analysis model.

### Step 8:

The server executes the emotion analysis model and generates emotion state data. The server supplies the embedding sequence and the numeric feature vector to a neural network-based emotion analysis model that has been pre-trained. The server propagates the embeddings through multiple transformer encoder layers to compute contextualized representations, then passes a pooled representation and the numeric features to a classification layer that outputs probabilities for emotion categories.

Input: Embedding sequence for the prompt sentence and numeric features derived from operation information.

Processing: The server performs matrix multiplications, attention computations, nonlinear activations, and residual connections according to the model's architecture; the server concatenates or otherwise combines text-based representations with numeric features and applies a fully connected layer followed by a softmax function to compute category probabilities. The server compares these probabilities and numeric features with predetermined thresholds and applies rule-based logic to decide an emotion label such as anger, anxiety, or neutral and corresponding intensity scores.

Output: Emotion state data including an emotion label and one or more intensity scores, added to the request context.

### Step 9:

The server constructs an internal prompt sentence for a generative AI model.

The server retrieves template text that contains placeholders for the prompt sentence, the tone designation information, and the emotion label. The server inserts the current values into the template by string replacement.

Input: Prompt sentence, tone designation information, and emotion state data from the request context; template text stored in configuration.

Processing: The server replaces placeholder tokens in the template with the actual prompt sentence, a textual representation of the emotion label, and the selected tone; the server may append explicit instructions such as “avoid aggressive expressions” or “use calm and polite language” when the emotion label indicates anger or anxiety.

Output: An internal prompt sentence tailored for the generative AI model, stored in the request context.

### Step 10:

The server generates a draft document using the generative AI model.

The server tokenizes the internal prompt sentence according to the generative AI model's vocabulary and feeds the token IDs into the model. The server causes the model to generate a sequence of output tokens by iteratively predicting next-token probabilities and selecting tokens using a decoding strategy.

Input: Internal prompt sentence string from the request context.

Processing: The server encodes the internal prompt sentence into token IDs, passes them through the generative AI model's layers (for example, transformer decoder layers), computes next-token distributions via matrix multiplications and softmax, and selects tokens using greedy selection or a sampling method. The server decodes the resulting token IDs into a text string and parses the string to extract a subject line and body text, for example by detecting lines beginning with a “Subject” marker or by predefined separators.

Output: A draft document object containing subject text and body text stored in memory.

### Step 11:

The server performs grammar analysis and correction on the draft body text.

The server sends the body text to a grammar analysis engine and receives error information that identifies positions and types of grammar, spelling, and punctuation errors.

Input: Draft body text from the draft document object.

Processing: The server calls the grammar analysis engine, which internally tokenizes the text, constructs syntactic representations, and matches content against grammar and spelling rules to produce error information. The server then iterates over each error entry and applies string replacements or modifications in the body text according to suggested corrections. The server may use index offsets to update the body text accurately while maintaining annotation integrity.

Output: A corrected body text with grammar, spelling, and punctuation errors reduced or removed, which replaces the original body text in the draft document object.

### Step 12:

The server detects emotional expressions and generates tone-adjustment proposals when necessary.

When the emotion state data indicates that the user's emotion level exceeds a threshold, the server applies additional analysis to identify emotional emphasis expressions.

Input: Corrected body text from the draft document object and emotion state data from the request context; emotional expression dictionary and substitution table from storage.

Processing: The server scans the body text using string matching or pattern matching to find segments that match entries in the emotional expression dictionary; for each match, the server retrieves one or more moderate alternative expressions from the substitution table or constructs a short rewriting prompt sentence for the generative AI model and obtains a paraphrased expression. The server annotates the body text with position indices and attaches the list of alternative expressions as tone-adjustment proposals.

Output: An annotated body text with identified emotional expressions and associated tone-adjustment proposals, stored in an annotation list in the request context.

### Step 13:

The server performs compliance analysis on the corrected and annotated body text.

The server invokes a morphological analysis component to segment the body text into tokens and then compares these tokens against entries in a compliance dictionary and rule set. Input: Corrected body text and emotional annotations; compliance dictionary and rules stored in server storage.

Processing: The server tokenizes the text into words or morphemes, assigns part-of-speech tags, and examines token sequences to detect phrases that match prohibited expressions, confidential-information indicators, or other non-compliant patterns. For each match, the server records the location, classifies the type of potential violation, and retrieves recommended alternative expressions or guideline messages. The server aggregates these into a compliance-violation candidate list.

Output: A list of compliance-violation candidate expressions with their positions, types, and suggested corrections and warnings, attached to the draft document context.

### Step 14:

The server compiles display data for the terminal.

The server aggregates the subject, the corrected and annotated body text, the emotion state data, tone-adjustment proposals, and the compliance-violation candidate list into a unified data structure for the user interface.

Input: Draft document object (subject and corrected body), emotion state data, emotional annotations and proposals, and compliance-violation candidate list.

Processing: The server creates a structured representation that includes the text content and metadata such as character spans for highlights, types of issues (emotional or compliance), and lists of candidate replacements. The server serializes this representation into a format suitable for network transmission, such as JSON.

Output: A serialized display-data payload encapsulating all information required to render a preview and suggestions on the terminal.

### Step 15:

The server sends the display data to the terminal.

The server writes the serialized display data into an HTTP or HTTPS response and transmits it back to the terminal via the network interface.

Input: Serialized display-data payload in server memory.

Processing: The server attaches appropriate headers, sets a response status, and uses the underlying network stack to deliver the payload over a transport protocol.

Output: A network response containing the display data received by the terminal.

### Step 16:

The terminal renders the draft preview and interactive annotations.

The terminal parses the received display data and updates the mail-generation screen to show the generated subject and body, together with visual indications for emotional expressions and compliance-violation candidates.

Input: Serialized display-data payload received in the HTTP or HTTPS response. Processing: The terminal deserializes the payload into an in-memory structure, binds the subject and body text to UI components, and applies visual styles (such as highlighting or underlining) to character ranges associated with annotations; the terminal also creates interactive elements such as buttons for “tone relaxation” and option menus for applying specific correction proposals.

Output: An updated UI showing a preview of the draft document with interactive annotations and controls.

### Step 17:

The user reviews the draft and optionally edits the text or applies suggestions. The user examines the highlighted segments on the terminal, manually edits the body text by typing new content, or selects specific tone-adjustment proposals or compliance-correction proposals from the UI. The user may also invoke a tone-relaxation function for the entire body.

Input: Current UI state with subject, body text, and annotations; user mouse, touch, or keyboard actions.

Processing: The terminal updates its local text buffer based on user edits, applies selected proposals by replacing specified ranges of text with the chosen alternatives, and updates visual annotations accordingly. When the user performs a significant action such as requesting tone relaxation or confirming the batch application of suggestions, the terminal constructs an update request that includes the current body text, subject, and an action type. Output: Updated text in the UI and, when necessary, a serialized update-request payload prepared for transmission to the server.

### Step 18:

The terminal sends the update request to the server for further processing.

The terminal serializes the update information, including the current body text, subject, and action type (for example, tone-relaxation request), and sends this payload to a designated server endpoint.

Input: Updated draft state (subject and body) and action type in the terminal memory.

Processing: The terminal uses its network stack to create an HTTP or HTTPS POST request, sets headers, writes the serialized payload to the request body, and transmits the request. Output: A network request conveying the update information to the server.

### Step 19:

The server regenerates or updates the draft based on the update request.

The server receives the update request, parses the payload, and replaces the stored subject and body text in the draft document with the user-edited versions. If the action type is a tone-relaxation request, the server constructs a new internal prompt sentence that instructs the generative AI model to rewrite the body into a calmer, more considerate form while preserving content.

Input: Serialized update-request payload including current body text, subject, and action type. Processing: The server deserializes the payload, updates the draft document object, and, for tone relaxation, builds a new internal prompt sentence and calls the generative AI model to produce a rewritten body. The server then re-applies grammar analysis and compliance checking to the rewritten body text, following the same procedures as in the earlier steps, and updates annotations and proposals.

Output: A refreshed draft document, updated annotations (emotional and compliance), and corresponding display data serialized for return to the terminal.

### Step 20:

The server returns the updated draft and annotations to the terminal.

The server constructs a new display-data payload containing the updated subject, body, emotion state data (if changed), and new lists of suggestions, and sends it as an HTTP or HTTPS response.

Input: Updated draft document object and associated analysis results in server memory.

Processing: The server aggregates the updated information into a structured object, serializes it, and transmits it as part of the network response.

Output: A response carrying the updated display data, which the terminal uses to refresh the UI.

### Step 21:

The user approves the final draft and initiates transmission.

After reviewing the final draft on the terminal, the user presses a send button. The terminal collects the latest subject, body text, destination information, and attachment information from the UI fields.

Input: Final subject, body, destination information, and attachment information as present in the UI at the time of the send action.

Processing: The terminal bundles these values into a send-request object, serializes the object, and attaches it to an HTTP or HTTPS POST request for the server.

Output: A serialized send-request payload transmitted to the server.

### Step 22:

The server validates the send request and performs emotion-based transmission timing control.

The server receives the send request, parses the payload, and extracts destination information, subject, body, and attachment information. The server validates the destination information using pattern matching against predefined address formats, checks subject length against policy limits, and validates attachment types and sizes. The server retrieves the emotion state data associated with the current draft and checks whether emotion intensity exceeds a threshold.

Input: Serialized send-request payload and emotion state data from the request context. Processing: The server executes string pattern checks, length comparisons, and data type checks on the received values; the server compares the stored emotion intensity with configured thresholds. If the emotion level is high, the server decides to apply a cooling-off mechanism and generates options such as immediate transmission or reconfirmation after a delay. If not high, the server approves immediate sending.

Output: Either a control response indicating available timing options for the terminal, or an internal decision to proceed directly to email transmission.

### Step 23:

The terminal presents transmission-timing options to the user when required.

When the server indicates that the emotion level is high and offers timing options, the terminal displays a dialog that explains the situation and presents options such as “send now” and “review again after a certain time.”

Input: Control response from the server indicating timing options and associated messages. Processing: The terminal parses the response, creates UI components such as buttons representing each option, and displays explanatory text describing the system's recommendation. The terminal waits for the user to select an option.

Output: A user-visible dialog with timing options and a record of the user's eventual selection.

### Step 24:

The server executes transmission scheduling or immediate sending based on the user's selection.

If the user selects immediate sending, the terminal notifies the server, and the server constructs a final email message; if the user selects reconfirmation after a delay, the terminal sends a message indicating this choice, and the server registers a scheduled task. Input: User selection (immediate send or delayed reconfirmation) sent from the terminal. Processing: For immediate sending, the server formats the email according to protocols, assembling headers, subject, body, and attachments into a MIME message and using an email transport protocol client to transmit the message to a mail server. For delayed reconfirmation, the server records a scheduled event with a time stamp and an identifier for the draft, and configures a scheduler to trigger re-preview display at the specified time.

Output: Either a successfully transmitted email or a scheduled task that will later prompt re-preview and final confirmation by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems that generate business texts using natural language processing or generative AI models typically treat user input as a static textual instruction and do not exploit fine-grained information about how the instruction was entered. Such systems generally receive a single prompt sentence from a client device, pass this sentence to a generative model, and then optionally perform simple grammar checking or keyword-based compliance filtering. These approaches suffer from several technical limitations in computer-based text generation workflows.

First, existing systems do not leverage detailed input operation histories-such as total input time, error corrections, and re-edit operations—as machine-readable behavioral signals. As a result, the server-side processing pipeline is unable to infer the user's cognitive load or interaction difficulties from the raw interaction data produced at the user terminal. The generative AI model is therefore driven by a limited input context (the prompt sentence text alone), which reduces the system's ability to adapt the generation behavior to the user's real-time state.

Second, known text generation architectures do not integrate multimodal indicators of user state, specifically the combination of text-derived emotion and input-log-derived behavioral features, into a unified control signal for the generation process. Conventional systems may perform sentiment analysis on the prompt sentence or classify user intent, but they do not jointly analyze emotional categories (for example, stress, confusion, or anxiety) and behavioral indicators (for example, hurry level, inattentiveness level, or fatigue level). Without such integration, the server cannot systematically adjust generation parameters, text structure, and user interface behavior according to the user's fluctuating state, which limits the adaptability and robustness of the computer system.

Third, even where grammar checking and compliance checking are applied, they are often implemented as loosely coupled, rule-based filters that operate independently of the user's state and the generative AI configuration. These filters typically apply fixed rules to detect spelling errors or certain prohibited terms, without dynamically modifying the generated text structure or safety content based on an integrated assessment of user state. This results in inflexible pipelines that either over-generate warnings and details, causing information overload, or under-specify safety and compliance information, thereby increasing the risk of omissions.

Fourth, existing systems that output business documents rarely propagate the integrated user state into the user interface control logic on the client side. The display format, emphasis of key steps, and expansion of supplementary information are usually static or only superficially configurable, and are not derived from a machine-learned model of user emotion and behavior. Consequently, the downstream human-computer interface does not effectively support users who may be under high stress or confusion, leading to higher error rates and inefficient task execution.

In summary, there is a need for a computer-implemented system that improves the overall text generation pipeline by: (i) capturing and using detailed input operation history as a behavioral signal; (ii) estimating and integrating emotional and behavioral states into a unified control variable; (iii) driving both generative AI model parameters and compliance/grammar processing based on this variable; and (iv) controlling the user interface rendering on the client device according to the same integrated state. Such a system would technically improve the functioning of the computer by enabling adaptive, state-aware generation and presentation of work instructions and other business texts, rather than merely automating text creation in a static manner.

The specific processing by the specific processing unit 290 of the data processing device 12 in Application Example 2 is realized by the following means.

The present invention provides a server comprising a processor and a memory storing instructions, wherein the processor is configured to acquire, from a user terminal, a prompt sentence indicating work content and an input operation history associated with input of the prompt sentence; to perform natural language processing on the prompt sentence and behavior analysis on the input operation history in order to estimate an emotional state and a behavioral state of a user and to generate integrated emotion information by integrating the emotional state and the behavioral state; to determine, based on the integrated emotion information, control information defining at least a style of an input prompt sentence for a generative AI model, a level of detail, a structure, and a writing style of an output text generated by the generative AI model, and a display format on the user terminal; to construct, based on the prompt sentence and the control information, the input prompt sentence to be supplied to the generative AI model and to automatically generate, by using the generative AI model, a business-related natural language text; to perform grammatical analysis on the automatically generated natural language text, to detect grammatical errors, inconsistent notations, and unnatural expressions, and to generate a corrected text; to compare the corrected text with predetermined normative information and to generate a compliance-checked text by automatically supplementing missing cautions and inappropriate expressions according to at least one of a safety standard and a compliance standard; to generate user interface control information, based on the integrated emotion information and the control information, the user interface control information defining at least a display format, emphasis portions, and expansion states of supplementary information for the compliance-checked text, and to transmit the user interface control information and the compliance-checked text to the user terminal; and to convert, in response to a final approval instruction received from the user terminal, the compliance-checked text into work document data in a predetermined output format and to distribute the work document data to at least one of a work terminal and an output device. This enables a computer-implemented text generation and presentation pipeline in which the server adaptively controls generative AI model behavior, grammar and compliance processing, and user interface rendering based on an integrated estimate of user emotion and behavior, thereby improving the technical functioning of the system over conventional static text generation architectures.

The term “system” refers to a combination of at least one server device, at least one terminal device, and associated software modules that cooperatively perform text generation, analysis, and distribution processing.

The term “server” refers to an information processing apparatus including at least one processor, a memory, a storage device, and a communication interface, the information processing apparatus being configured to execute programs to implement acquisition, analysis, generation, checking, and distribution of texts.

The term “processor” refers to one or more processing units, such as a central processing unit or a graphics processing unit, that execute instructions stored in a memory to perform arithmetic operations, logical operations, control operations, and data processing.

The term “memory” refers to a volatile or non-volatile storage medium, such as a random access memory or a read-only memory, that stores programs, models, configuration data, and intermediate data used by the processor.

The term “user terminal” refers to an information processing apparatus operated by a user, the information processing apparatus including at least a display device, an input device, a communication interface, and an execution environment for a user interface program, and being configured to transmit input data to the server and display output data received from the server.

The term “work terminal” refers to an information processing apparatus used by a worker to receive and view work document data, the information processing apparatus being distinct from or overlapping with the user terminal.

The term “output device” refers to a device that outputs information in a human-perceptible format, including at least one of a printing device, a display device, and a storage system for distributing electronic documents.

The term “prompt sentence” refers to a natural language text input by a user via the user terminal, the text indicating at least work content or work purpose, and serving as an input condition for a generative AI model.

The term “input operation history” refers to data indicating a temporal sequence of input operations performed by a user on an input interface of the user terminal, the data including at least timestamps, key codes or input events, and counts of corrections and re-edits associated with entry of a prompt sentence.

The term “natural language processing” refers to computerized processing applied to natural language text, including at least tokenization, morphological analysis, syntactic analysis, semantic analysis, and statistical or neural inference.

The term “behavior analysis” refers to computerized processing of the input operation history to extract feature quantities and to infer behavioral characteristics, including at least attention state, hurry state, and fatigue state.

The term “emotional state” refers to information indicating a psychological condition of a user, expressed as one or more emotion categories, such as stress, confusion, anxiety, or neutral, and an intensity associated with each category.

The term “behavioral state” refers to information indicating a behavioral condition of a user, expressed as at least one behavioral indicator, such as inattentiveness level, hurry level, or fatigue level, inferred from the input operation history.

The term “integrated emotion information” refers to information obtained by combining the emotional state and the behavioral state, the information classifying an overall user state into at least one integrated category, such as a high-stress state or a confused state, and optionally including intensity values.

The term “control information” refers to configuration information determined based on the integrated emotion information, the configuration information defining at least parameters for constructing an input prompt sentence for a generative AI model, parameters for controlling a level of detail, a structure, and a writing style of an output text, and parameters for controlling display behavior on the user terminal.

The term “generative AI model” refers to a generative machine learning model, trained in advance on a large amount of text data, and configured to generate natural language text in response to an input prompt sentence.

The term “input prompt sentence for a generative AI model” refers to a natural language text, possibly including system instructions and user instructions, constructed based on the prompt sentence and the control information, and supplied as input to the generative AI model. The term “business-related natural language text” refers to a natural language text automatically generated by the generative AI model, the text describing at least work instructions, procedures, cautions, or other operational content for business use.

The term “grammatical analysis” refers to processing for examining the structure of a natural language text, including at least segmentation into sentences, part-of-speech analysis, and syntactic pattern evaluation for detecting grammatical inconsistencies.

The term “corrected text” refers to a natural language text obtained by applying automatic corrections to an automatically generated natural language text, the corrections including at least fixing grammatical errors, normalizing notations, and replacing unnatural expressions. The term “normative information” refers to stored reference information defining desirable or required content and expressions, including at least safety standards, legal compliance standards, and internal guidelines.

The term “compliance-checked text” refers to a natural language text obtained by comparing the corrected text with the normative information and automatically supplementing missing cautions or correcting inappropriate expressions so as to meet at least one of a safety standard and a compliance standard.

The term “user interface control information” refers to configuration information for controlling a user interface on the user terminal, the configuration information defining at least a display format, emphasis portions, visibility of supplementary information, and expansion states of sections for the compliance-checked text.

The term “work document data” refers to structured document data generated from the compliance-checked text, the structured document data having a predetermined output format, such as an electronic document format or a print-ready format.

The term “predetermined output format” refers to a document format specified in advance for outputting work document data, including at least one of a fixed-layout electronic document format and a printable page description format.

The term “safety standard” refers to rule information defining required or recommended safety-related instructions, cautions, and procedures corresponding to specific types of work, equipment, or environments.

The term “compliance standard” refers to rule information defining requirements for legal conformity, policy adherence, or ethical guidelines applicable to the content of a text. The term “feature quantities” refers to numerical values derived from the input operation history, including at least a total input time, a character count, a number of erroneous inputs, a number of re-edits, and an input time per character.

The term “machine learning model” refers to a computational model trained on example data to learn mappings from input feature quantities to output values, such as behavioral state scores.

The term “behavioral state score” refers to a numerical value output from the machine learning model, indicating a degree or level of a behavioral attribute, such as inattentiveness, hurry, or fatigue.

The term “display format” refers to a set of visual layout and style settings applied to text or user interface elements on a display device, including at least font attributes, color attributes, arrangement, and grouping.

The term “emphasis portion” refers to a part of a text or a user interface element rendered with a visual emphasis, such as bold type, color highlighting, or icon attachment, to draw user attention.

The term “expansion state” refers to a state indicating whether a section of supplementary information, such as a help section or detailed explanation, is displayed in an expanded form or a collapsed form in the user interface.

The term “final approval instruction” refers to an instruction input by a user via the user terminal, the instruction indicating authorization to convert a compliance-checked text into work document data and to distribute the work document data.

In an embodiment, a server, a terminal, and a user cooperate to implement a system for generating, checking, and distributing work-related documents using a generative AI model based on a prompt sentence and an input operation history.

A server is implemented as an information processing apparatus including at least one processor, a main memory, a non-volatile storage device, and a network interface. The server executes an operating system such as a general-purpose server OS and application programs including a web application framework, a natural language processing library, a machine learning framework, and a document generation library. The server loads and executes program modules that implement acquisition processing, emotion and behavior estimation processing, control information determination, generative AI prompting, grammar checking, compliance checking, user interface control generation, and document distribution.

A terminal is implemented as an information processing apparatus such as a smartphone, a tablet device, a notebook computer, or a desktop computer. The terminal includes at least a display device, an input device, a local memory, a processor, and a network interface. The terminal executes an operating system such as a mobile operating system or a desktop operating system and runs a user interface program, such as a web browser using HTML, CSS, and JavaScript or a native application using a platform-specific UI framework. The terminal displays input screens, acquires user operations, constructs structured data including a prompt sentence and an input operation history, and exchanges messages with the server via a secure communication protocol such as HTTPS over TLS.

A user operates the terminal to input a prompt sentence describing work content. The user may input, for example, one of the following prompt sentences:

“Picking items for the next shipment.”

“Perform inventory counting.”

“Pack products for shipment.”

“Inspect returned goods and restock them.”

The terminal records not only the final text of the prompt sentence but also the detailed input operation history. The terminal records an input start time when the user brings focus to a text input field, records each key event including a key code and a timestamp, and records an input end time when the user activates a send control. The terminal counts correction operations such as backspace key presses and full text deletions followed by re-input. The terminal computes numerical values including a total input time, a number of erroneous inputs, a number of re-edits, and an average input time per character. The terminal stores the prompt sentence and these numerical values in a structured data format in the local memory, and the terminal transmits this structured data to the server via the network interface using an HTTP client library.

The server receives the prompt sentence and the input operation history via the network interface and a web application framework. The server deserializes the received data, stores it in the main memory as records or objects, and applies preprocessing to the prompt sentence. The server uses a text preprocessing module to normalize the character encoding, unify whitespace, and convert punctuation and character forms into a canonical representation configured for a downstream natural language processing pipeline. This canonical representation improves consistency of tokenization and reduces branching in downstream neural inference, thereby improving processing speed and inference stability.

The server executes a natural language processing module implemented on a machine learning framework such as a deep learning framework. The server loads a pre-trained language model implementing a transformer-based neural network architecture. In one embodiment, the server uses a model that includes an embedding layer, a plurality of self-attention layers, feed-forward sublayers, and a classification head. The server applies a tokenizer such as a subword segmentation algorithm to the normalized prompt sentence, maps each token to an integer index by a vocabulary table, and creates a sequence tensor. The server feeds the sequence tensor into the pre-trained language model, and the processor performs matrix multiplications, non-linear activations, and attention-weighted summations across multiple layers.

The server obtains, from the classification head of the model, a vector of real-valued outputs. The server applies a softmax function to convert these outputs into probabilities corresponding to emotion categories such as stress, confusion, anxiety, and neutral. The server identifies a primary category and its probability as an emotional state. Because the server uses a transformer-based architecture that models contextual dependencies across the entire prompt sentence, the server achieves higher classification accuracy for short, ambiguous user inputs than a simple keyword-based or rule-based method. The architecture's multi-head attention enables the server to capture long-range dependencies and subtle sentiment cues, contributing to improved estimation of the user's emotional state. The server performs behavior analysis based on the input operation history. The server extracts numerical feature quantities from the operation history, including at least a total input time, a total character count, a number of erroneous inputs, a number of re-edits, and an average input time per character. The server arranges these feature quantities into a feature vector data structure suitable for numerical computation. The server loads a trained machine learning model, such as a gradient boosting model or another supervised regression or classification model, from the storage device into memory.

The server feeds the feature vector into the machine learning model. The processor applies a series of decision tree evaluations or linear transformations to compute behavioral state scores such as an inattentiveness level, a hurry level, and a fatigue level. The server uses a model that has been trained in advance on labeled training data including input operation histories and associated behavioral labels. During training, the server adjusts model parameters, such as tree splits or weight vectors, to minimize a loss function, such as cross-entropy for classification or mean squared error for regression. The server may augment training data by applying noise or slight scaling to timing features to improve generalization. Because this model uses fine-grained timing and error count features, the server can estimate behavioral states more accurately than a human observer could deduce from the final text alone. The server integrates the emotional state and the behavioral state into integrated emotion information. The server applies a rule engine or a meta-model that takes as input the emotion category probabilities and the behavioral state scores. For example, the server may apply logic such that if the stress probability exceeds a threshold and the hurry level exceeds a threshold, then the integrated state is set to a high-stress state; if the confusion probability exceeds a threshold and the number of erroneous inputs is high, then the integrated state is set to a confused state. The server may alternatively implement a small neural network that takes the emotion probabilities and behavioral scores as inputs and outputs a discrete integrated category. This explicit integration step produces a machine-interpretable control variable that condenses multiple signals into a compact, decision-ready representation, improving computational efficiency in the downstream decision logic.

The server determines control information based on the integrated emotion information. The server maintains, in the storage device, control rule definitions that map integrated states to generation and display parameters. The server retrieves relevant rules and generates a configuration object that includes parameters such as a target level of textual detail, a preferred sentence length, a preference for bullet-point versus paragraph structure, and flags for including or excluding explanatory sections. For example, if the integrated state is a high-stress state, the server sets parameters indicating short total text length, bullet-point structure, and brief safety notes. If the integrated state is a confused or anxious state, the server sets parameters indicating detailed stepwise explanations, inclusion of device operation instructions, and extended safety descriptions.

The server constructs an input prompt for the generative AI model using the original prompt sentence and the control information. The server assembles a system instruction string and a user instruction string. The system instruction string encodes the style and structural constraints determined by the control information. The user instruction string reformulates the user's prompt sentence into an explicit request for a work instruction document. For example, when the prompt sentence is “Picking items for the next shipment.” and the integrated state indicates high stress, the system instruction can be:

“You are a system that creates work instructions for a logistics site. Use concise and easy-to-understand language. Present steps as short bullet points. Briefly include only essential safety notes. Avoid long paragraphs.”

The user instruction can be:

“Create a work instruction document for picking items for the next shipment in a logistics center. List the main steps as bullet points and include brief safety notes related to item handling and movement in the warehouse.”

The server combines these instruction strings into a structured input conforming to the interface requirements of the generative AI model. The server thereby enforces explicit constraints on the generative AI model's output, which leads to more predictable and controlled generation than direct free-form prompting. This structured control mitigates unpredictable behavior and reduces the need for extensive post-processing, improving computational efficiency and reducing communication overhead by avoiding repeated queries.

The server uses a generative AI model implemented as a pre-trained transformer-based language model for text generation. The server either calls an external inference service via an HTTPS API or executes a model instance locally using a deep learning framework. The generative AI model includes an embedding layer, multiple transformer blocks, and a language modeling head that predicts probability distributions over vocabulary tokens at each position. During inference, the server sets parameters such as a maximum token length, a temperature for sampling, and top-k or top-p values to balance diversity and determinism. The server feeds the constructed input prompt to the generative AI model, and the processor performs sequential token generation, selecting tokens according to probabilistic sampling rules.

The server collects the generated tokens and converts them into a natural language string representing a draft business-related text, such as a work instruction. Because the generative AI model incorporates a large number of parameters and a rich training corpus, the model can produce contextually appropriate and domain-consistent instructions. The server's control information shapes the generation process toward concise or detailed output depending on the integrated emotion information. This adaptive prompting results in lower average token counts in high-stress scenarios, reducing processing time and network bandwidth consumption, while still preserving key information.

The server performs grammatical analysis on the generated draft text. The server uses a natural language processing library including a morphological analyzer and a rule-based grammar checker. The server divides the draft text into sentences according to punctuation and line or token boundaries, and the server applies morphological analysis to identify parts of speech and inflectional forms. The server then applies a set of grammar rules and pattern-matching rules to detect errors such as incorrect particle usage, inconsistent styles, and non-standard spellings. For example, the server detects instances of a polite imperative form written inconsistently and normalizes them to a standard form. The server generates a corrected text by replacing erroneous segments with corrected forms and by unifying style variants.

The server compares the corrected text with normative information representing safety standards and compliance standards. The server maintains a database or a structured file set that associates keywords or phrase patterns with standard safety instructions and legal compliance statements. For example, the server maps keywords like “high place work,” “heavy load,” and “forklift” to standard instructions such as “wear safety equipment,” “use proper lifting techniques,” and “check surroundings before operation.” The server scans the corrected text for these keywords and phrase patterns using string search or pattern matching. When the server detects a task type without the corresponding safety instruction, the server inserts the standard safety instruction into the text at a logical position, such as after a step that mentions a hazardous activity. The server thus produces a compliance-checked text that conforms to defined safety and compliance standards. This automated alignment reduces human error and variance in document content and provides a reproducible, machine-enforceable compliance mechanism.

The server generates user interface control information using the integrated emotion information and the control information. The server translates high-level parameters into specific display control flags and layout instructions. For example, for a high-stress state, the server sets flags for highlighting main steps, minimizing initially visible supplementary information, and simplifying the layout. For a confused state, the server sets flags for automatic expansion of help sections, prominent display of explanations, and strong visual emphasis on safety notes. The server embeds these flags and, optionally, structure markers (for example, identifiers of main steps and warning sentences) into a structured data object. The server transmits the compliance-checked text and the user interface control information to the terminal over a secure network connection. The terminal receives the structured data, parses it, and maps the control flags to UI elements. The terminal uses its UI framework to render the text, applying styles and layout such as bold emphasis, colored highlighting, indentation, and collapsible sections according to the control information. Because the UI behavior is controlled by server-generated, state-dependent flags, different users or different sessions produce different UI layouts, even when the underlying work content is similar. This dynamic adaptation improves readability and reduces cognitive load, especially for users in high-stress or confused states.

The user reviews the compliance-checked text as rendered by the terminal. The user may modify portions of the text via editable fields if allowed, and the terminal can send updated text back to the server for additional checking. Once satisfied, the user issues a final approval instruction through the terminal's interface. The terminal sends a structured approval message to the server, including identifiers of the relevant text and distribution targets.

The server, upon receiving the final approval instruction, retrieves the compliance-checked text and associated metadata such as a work title, a date, and assignment information. The server uses a document generation library, such as a PDF generation library, to convert the text and metadata into work document data in a predetermined output format. The server defines page layouts, fonts, and section headings programmatically, and the processor generates a structured document file. The server stores the document in a storage system and distributes it via email, a portal, or a print queue to work terminals or output devices. Because the server generates documents in a consistent structured format, downstream systems can archive, search, and retrieve documents efficiently.

This system produces technical effects beyond mere automation of human document drafting. The integration of prompt sentence analysis, input operation history, and machine-learned emotion and behavior estimation improves the server's ability to adjust model parameters and interface behavior automatically. As a result, the server reduces the average number of generative AI iterations, lowers token consumption in scenarios where shorter text is appropriate, and improves compliance coverage by systematically checking for safety omissions. The explicit use of timing and error features in a machine learning model allows the server to infer user state in real time, something that is not feasible with static text-only processing. This leads to improved computational efficiency, reduced network traffic for repeated corrections, and fewer user-initiated revisions.

In another embodiment, the server may use a different neural architecture, such as a recurrent neural network with attention, or may integrate the emotion classification and behavior estimation models into a single multi-task network. The server may also vary the loss functions, using, for example, a weighted cross-entropy that emphasizes accurate detection of high-stress or confused states. The server may choose alternative feature sets for the behavior model or may apply dimensionality reduction techniques to simplify the input space. The system may be configured to operate in domains other than logistics, such as manufacturing, maintenance, or medical workflows, while using the same underlying architecture for prompt sentence processing, integrated state estimation, and adaptive document generation and UI control.

In yet another embodiment, the terminal may implement part of the emotion estimation, for example performing lightweight timing analysis locally and sending intermediate features to the server to reduce bandwidth. The server may also adjust batch processing strategies or caching strategies for the generative AI model to further reduce computational cost when multiple similar prompt sentences are processed. These variations maintain the essential architecture in which the server uses detailed input behavior and emotional estimation to control generative AI model prompting, grammar and compliance processing, and user interface rendering, thereby improving the technical functioning of the computing system in terms of accuracy, speed, and resource utilization.

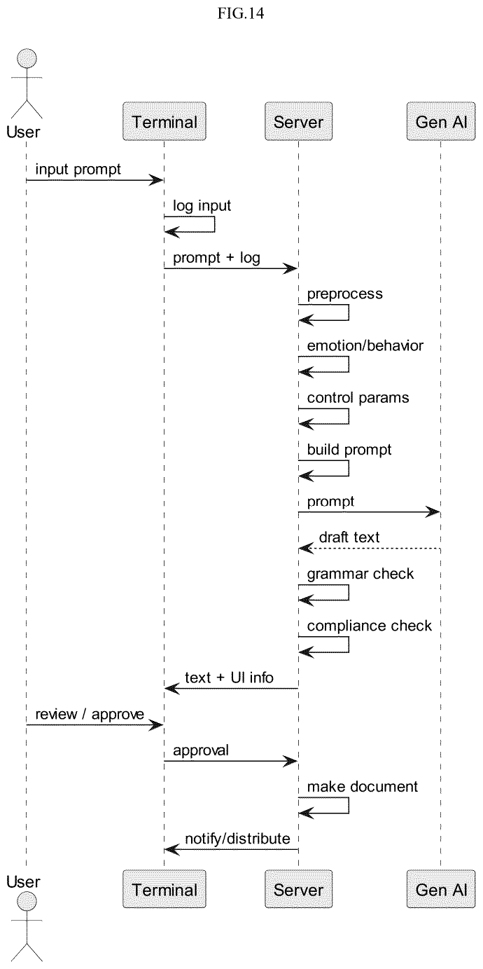

The following describes the processing flow using FIG. 14.

### Step 1:

User operates the terminal to input a prompt sentence.

User focuses a text input field displayed on the terminal and types a prompt sentence that indicates work content. Example prompt sentences include: “Picking items for the next shipment.”, “Perform inventory counting.”, “Pack products for shipment.”, and “Inspect returned goods and restock them.”

Input: User's keystrokes on the input field.

Output: A text string representing the final prompt sentence held in the terminal's input buffer.

### Step 2:

Terminal records an input operation history while the user is typing.

Terminal detects the focus event on the input field and records the current time as an input start timestamp in local memory. Terminal logs each key event (key code, timestamp, and whether it is a correction key such as backspace or delete) using UI event callbacks. Terminal records the input end timestamp when the user activates a send button. Terminal calculates a total input time by subtracting the start time from the end time, counts erroneous inputs by counting correction key presses, and detects re-edits by identifying full text deletions followed by new input.

Input: Sequence of key events and focus/blur events associated with the prompt sentence input.

Output: An input operation history data structure that includes at least the total input time, character count, number of erroneous inputs, number of re-edits, and average input time per character.

### Step 3:

Terminal constructs structured transmission data and sends it to the server.

Terminal combines the prompt sentence and the input operation history into a structured payload, such as a key-value object, and serializes it into a format suitable for network transmission (for example, JSON). Terminal uses an HTTP client library to establish an HTTPS connection to the server via the network interface, applies encryption using TLS, and transmits the serialized payload as a request body.

Input: The prompt sentence text and the input operation history data structure stored in terminal memory.

Output: An HTTPS request containing serialized prompt sentence data and input operation history data, sent to the server.

### Step 4:

Server receives and parses the request from the terminal.

Server, through a web application framework, accepts the HTTPS request via the network interface. Server decrypts the TLS stream at the transport layer, reads the request body, and deserializes the structured data into internal data objects. Server stores the prompt sentence and the input operation history in main memory for subsequent processing.

Input: Encrypted HTTP request containing the serialized prompt sentence and input operation history.

Output: In-memory data objects representing the prompt sentence string and the input operation history structure.

### Step 5:

Server performs text preprocessing on the prompt sentence.

Server applies a text preprocessing module to normalize the prompt sentence. Server removes leading and trailing spaces, collapses multiple spaces into a single space, normalizes character forms (for example, full-width to half-width where appropriate), and standardizes punctuation. Server may convert the text to a canonical encoding and representation used by downstream natural language processing components.

Input: Raw prompt sentence string as received from the terminal.

Output: A normalized prompt sentence string prepared for tokenization and emotion analysis.

### Step 6:

Server performs tokenization and emotion estimation based on the prompt sentence. Server uses a tokenizer associated with a pre-trained language model to split the normalized prompt sentence into tokens or subword units. Server maps tokens to integer IDs using a vocabulary table and forms an input tensor. Server feeds the tensor into a pre-trained transformer-based model using a machine learning framework. Server executes forward propagation through embedding layers, multi-head self-attention layers, and feed-forward layers until reaching a classification head that outputs raw scores for emotion categories such as stress, confusion, anxiety, and neutral. Server applies a softmax function to convert raw scores into probabilities and selects a primary emotion category and intensity.

Input: Normalized prompt sentence string.

Output: An emotion state object including probabilities for multiple emotion categories and a primary emotion label with its intensity.

### Step 7:

Server performs feature extraction and behavioral state estimation from the input operation history.

Server extracts numerical feature values from the input operation history, including at least total input time, total number of characters in the prompt sentence, number of erroneous inputs, number of re-edits, and average input time per character. Server arranges these numerical values into a feature vector structure. Server inputs the feature vector into a trained machine learning model, such as a gradient boosting model, and executes inference by traversing decision trees or applying learned weight parameters. Server obtains behavioral scores indicating inattentiveness level, hurry level, and fatigue level.

Input: Input operation history data structure.

Output: A behavioral state object including numerical scores for inattentiveness, hurry, fatigue, and related behavioral attributes.

### Step 8:

Server integrates the emotional state and the behavioral state into integrated emotion information.

Server takes the emotion probabilities and the behavioral state scores as inputs to a rule engine or a small meta-model. Server applies conditional rules such as: when stress probability and hurry level are both above predefined thresholds, classify the state as high-stress; when confusion probability and erroneous input count are both high, classify the state as confused; otherwise classify the state as stable or neutral. Alternatively, server may compute a weighted combination of emotion and behavioral scores and map the combined score to discrete integrated categories.

Input: Emotion state object and behavioral state object.

Output: Integrated emotion information that includes an integrated state label such as high-stress, confused, or stable, and optionally associated intensity values.

### Step 9:

Server determines generation and display control information based on the integrated emotion information.

Server references a control rule set stored in a configuration repository. Server, for a high-stress integrated state, sets generation parameters to favor shorter output length, bullet-point structure, and brief safety notes, and sets display parameters to emphasize main steps and reduce on-screen clutter. For a confused or anxious state, server sets generation parameters to increase the detail level, include step-by-step guidance and operation instructions, and sets display parameters to automatically expand help sections and highlight explanations. Server combines these parameters into a control information object that encompasses both generative AI configuration (such as target detail level and structure preference) and UI configuration (such as emphasis and expansion flags).

Input: Integrated emotion information.

Output: Control information object containing generation parameters and user interface parameters.

### Step 10:

Server constructs an input prompt for the generative AI model.

Server uses the control information and the original prompt sentence to generate a system instruction string and a user instruction string. Server encodes constraints such as “use concise language,” “use bullet points,” or “provide detailed stepwise explanations” into the system instruction. Server reformulates the prompt sentence into a clear instruction describing the required work instruction document in the user instruction. Server structures these instruction strings into the format required by the generative AI model interface, such as a list of messages with roles (system, user) and associated text.

Input: Original prompt sentence string and control information object.

Output: A structured generative AI input prompt containing system-level and user-level instructions.

### Step 11:

Server invokes the generative AI model to generate a draft business-related text. Server sends the structured input prompt, along with generation parameters such as model identifier, maximum output token length, temperature, and top-k or top-p settings, to a generative AI inference endpoint. Server uses an HTTP or RPC client to transmit the request and waits for the model's response. The generative AI model performs sequential token prediction using its transformer architecture, sampling tokens according to the specified parameters. Server receives the generated token sequence, decodes it to a natural language string, and aggregates it as a draft work instruction text.

Input: Structured generative AI input prompt and parameter settings.

Output: A draft business-related natural language text describing work instructions and related content.

### Step 12:

Server performs grammatical analysis and correction of the draft text.

Server splits the draft text into sentences based on punctuation and line breaks. Server applies a morphological analyzer and optionally a syntactic parser to each sentence to identify parts of speech and phrase structures. Server consults a set of grammar and style rules to identify grammatical errors, inconsistent spellings, and unnatural expressions. For each detected issue, server selects appropriate correction patterns, such as replacing a non-standard polite form with a standardized equivalent or correcting a misused particle. Server composes a corrected text by applying all corrections while preserving the original sentence structure where possible.

Input: Draft business-related natural language text.

Output: Corrected text with standardized grammar, unified notation, and improved readability.

### Step 13:

Server performs compliance checking and augmentation based on normative information. Server loads safety and compliance rule data from a storage repository. Server scans the corrected text for specific keywords and pattern matches that indicate hazardous work types or regulated activities. For each detected term, server checks whether corresponding standard safety instructions or legal compliance statements are already present in the text. When a required instruction is missing, server retrieves a predefined standard phrase from the normative data and inserts it into the corrected text at an appropriate location, such as before or after the step describing the hazardous action. Server thereby generates a compliance-checked text that fulfills the defined safety and compliance criteria.

Input: Corrected text and normative safety/compliance rule data.

Output: Compliance-checked text enriched with necessary safety instructions and legally required statements.

### Step 14:

Server generates user interface control information for the terminal.

Server converts high-level UI parameters in the control information into concrete display control flags and layout instructions. For example, server determines which segments of the compliance-checked text are main steps to be highlighted, which segments are warnings to be visually emphasized, and which sections should be initially expanded or collapsed. Server associates identifiers or markers with these segments and encodes style flags such as bold, highlight color, and collapsible section state. Server packages these flags and markers into a user interface control information object.

Input: Control information object and compliance-checked text structure.

Output: User interface control information describing display style, emphasis areas, and section expansion behavior for the compliance-checked text.

### Step 15:

Server transmits the compliance-checked text and user interface control information to the terminal.

Server serializes the compliance-checked text and the user interface control information into a structured response format. Server sends this response to the terminal over an HTTPS connection using the network interface. Server may compress the payload to reduce bandwidth, then the terminal receives and buffers the response for rendering.

Input: Compliance-checked text and user interface control information in server memory.

Output: An HTTPS response containing serialized compliance-checked text and UI control data delivered to the terminal.

### Step 16:

Terminal renders the compliance-checked text according to the user interface control information.

Terminal parses the received structured data and reconstructs the compliance-checked text and control flags. Terminal uses a UI framework to create visual elements for sections, steps, and warnings. Terminal applies style attributes such as bold, color highlighting, indentation, and collapsible panels based on the control flags, for example highlighting main steps and expanding help sections for confused users. Terminal then displays the rendered document on the display, allowing scrolling and interaction.

Input: Serialized compliance-checked text and user interface control information.

Output: A visually rendered work instruction screen adapted to the user's integrated emotion state.

### Step 17:

User reviews and optionally edits the displayed work instruction.

User reads the steps, warnings, and explanations on the terminal screen. If the interface allows editing, user modifies specific text fields, such as adding local notes or adjusting step descriptions. Terminal detects these edits via input events and updates the internal representation of the document. Terminal may provide functions to save locally or resend the edited content to the server for additional checking.

Input: Rendered work instruction on the terminal display.

Output: User-approved or user-edited work instruction content within the terminal.

### Step 18:

User issues a final approval instruction for document generation and distribution.

User confirms that the displayed work instruction is acceptable and then activates an approval or distribution control, such as an “Approve” button. Terminal interprets this interaction as a final approval instruction, attaches metadata such as document identifiers and distribution targets, and constructs an approval message. Terminal sends this message to the server over HTTPS using its network interface.

Input: User's approval action on the terminal interface.

Output: An approval instruction message containing document identification and distribution information transmitted to the server.

### Step 19:

Server generates work document data in a predetermined output format.

Server receives the approval instruction and retrieves the corresponding compliance-checked text and metadata from storage. Server uses a document generation library to layout the text into a structured document format such as a PDF or another fixed-layout format. Server programmatically defines page headers, section titles, body text, and optional signature fields, and the processor executes rendering routines to generate a document file. Server stores this file in a document repository or a file storage system.

Input: Compliance-checked text, associated metadata, and approval instruction.

Output: Work document data in a predetermined output format, such as a PDF file or print-ready format.

### Step 20:

Server distributes the generated work document data to work terminals or output devices. Server uses configured distribution channels, such as email systems, web portals, or print queues, to send the document file to the designated recipients. Server may attach the document to an email, provide a download link on a portal accessed by work terminals, or send the document to a network printer for physical output. Server logs the distribution results for tracking and auditing.

Input: Generated work document data and distribution target information.

Output: Delivered electronic documents to work terminals and/or printed documents from output devices, enabling workers to perform tasks according to the generated instructions.

The data generation model 58 is a so-called generative artificial intelligence (AI). Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

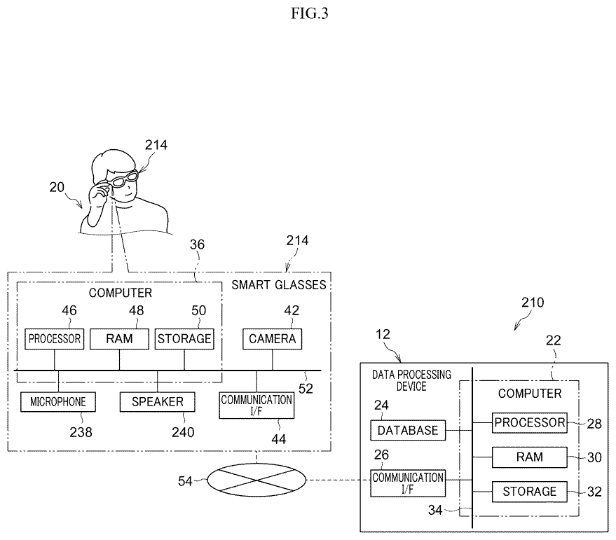

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

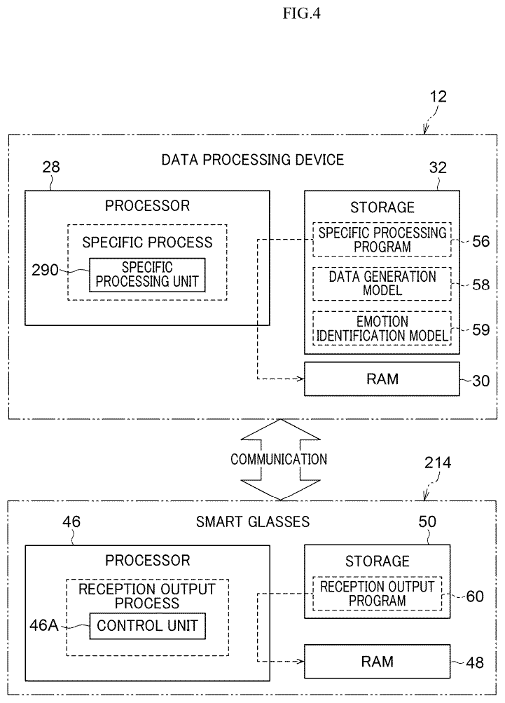

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

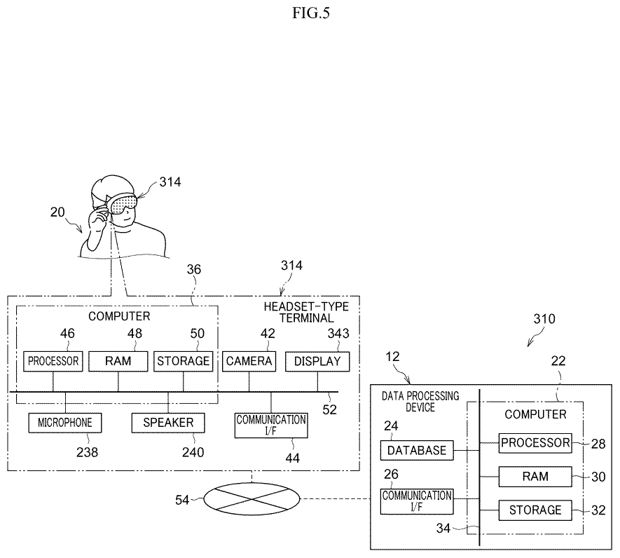

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

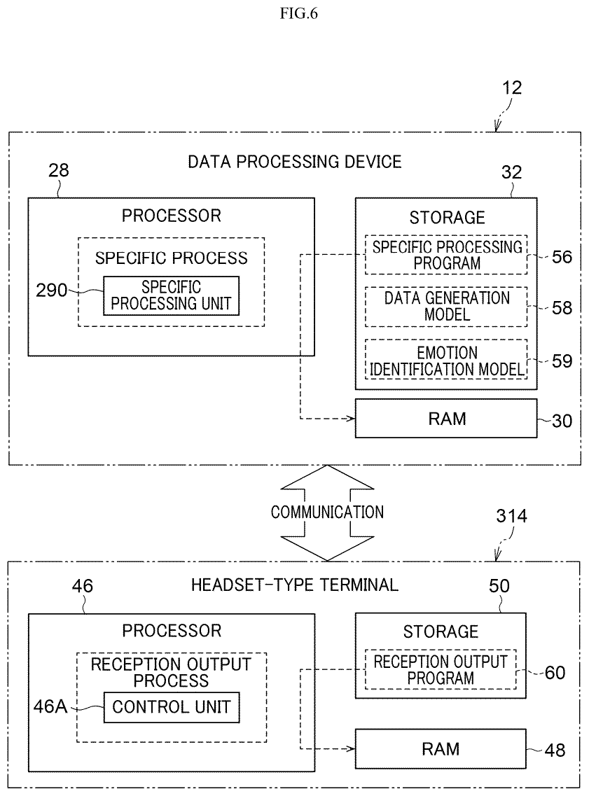

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

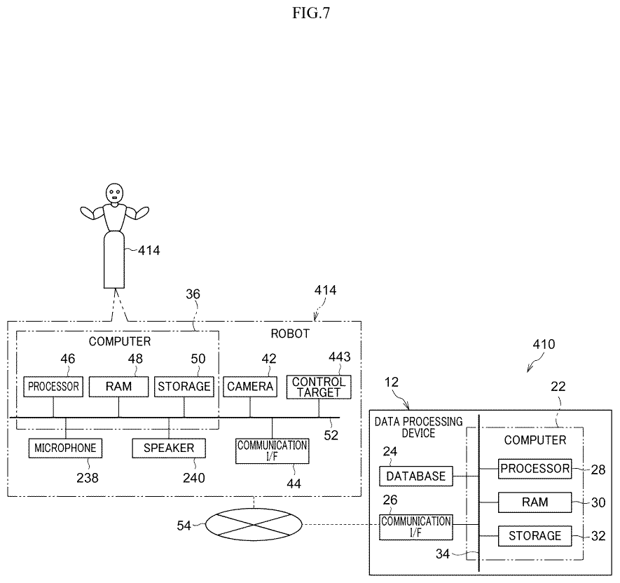

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

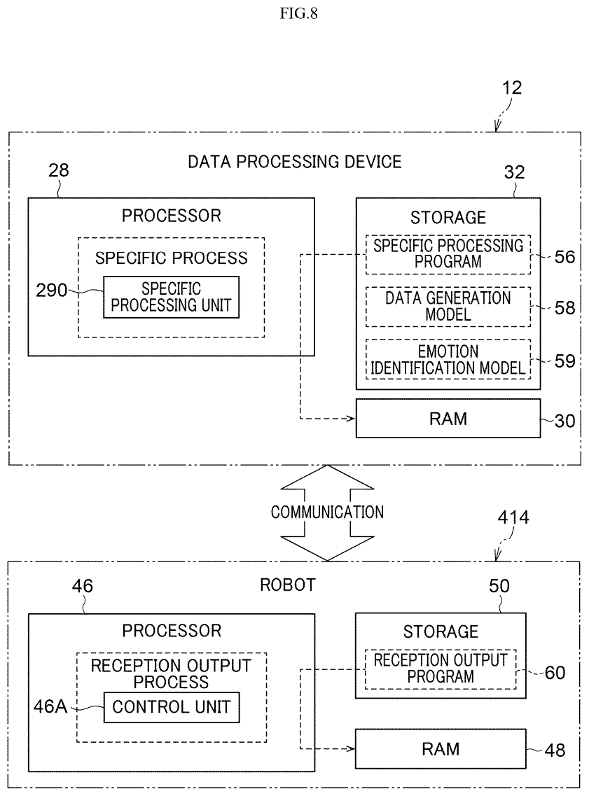

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

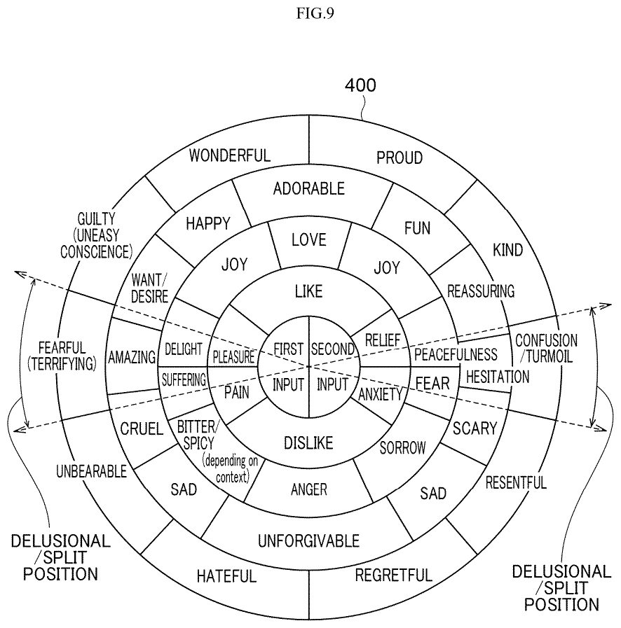

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

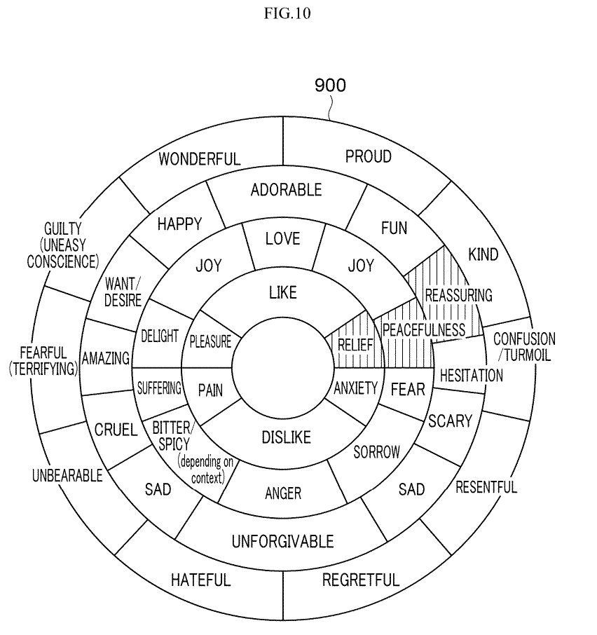

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire instruction information including business information from a user via a terminal
device, generate structured information including the instruction information, and generate a prompt sentence to be input to a generative AI model based on the structured information, and input the prompt sentence to the generative AI model and generate draft information of a business electronic message by performing text generation processing using a language model in the generative AI model, and
perform sentence division processing and language structure analysis processing on the draft information, detect spelling errors, punctuation errors, and syntactic inconsistencies, and automatically correct the draft information based on detection results, and
perform detection of specific expressions on automatically corrected draft information based on stored rule information and stored phrase information, determine conformity of the draft information to confidentiality protection criteria and expression criteria, extract a portion that violates or is likely to violate the criteria, and generate warning information, and
generate correction candidate information for rewriting a text portion associated with the warning information based on the generative AI model or replacement candidate data, and transmit display information including the automatically corrected draft information, the warning information, and the correction candidate information to the terminal device, and provide a user display control function that enables, on the terminal device, display, manual correction, and additional instruction input by the user, and
acquire finalized electronic message information from the terminal device, verify conformity of address information, subject information, and attachment information to format conditions and constraint conditions, and perform a message transmission process or an error notification process according to a verification result, and
transmit the electronic message information determined to be transmittable by a transmission preparation process to a message transfer device according to a transmission protocol.

### (Supplementary 2)

The system according to supplementary 1,
wherein the processor is configured to generate the prompt sentence by combining template information with user designation information including the instruction information and the additional instruction input received from the terminal device, and meta information indicating an application type, a recipient attribute, a writing style type, and a language type, construct a detailed prompt sentence for generating the business electronic message by the generative AI model, and perform a corrected document generation process including at least one of tone change, summarization, addition, and rewriting by repeatedly inputting the detailed prompt sentence to the generative AI model.

### (Supplementary 3)

The system according to supplementary 1,
wherein the processor is configured to
cause the terminal device to visually distinguish, on a display of the terminal device, grammatical correction portions in the automatically corrected draft information and text portions corresponding to the warning information, and, based on a selection operation of the correction candidate information or the additional instruction input, start a regeneration process by the generative AI model on a server side, and redisplay updated draft information obtained as a result of the regeneration process on the terminal device to provide an interactive editing function.

### Application Example 1

### (Supplementary 1)

A system comprising a processor,
wherein the processor is configured to
receive an operation instruction or objective input by a user through an input interface, and construct the received instruction as a prompt sentence to be input to a generative AI model, and automatically generate a draft work instruction document by using a natural language processing technique based on the prompt sentence and related operation data, as work instruction generation processing,
analyze sentences included in the draft work instruction document generated by the work instruction generation processing, detect errors relating to word form, punctuation, and sentence structure, automatically correct the errors, and format the draft work instruction document into grammatically correct text, as grammar check processing,
evaluate content of the grammatically formatted work instruction document against stored compliance rules including safety standards and operation procedures, determine presence or absence of predetermined keywords or phrases, and automatically supplement missing safety instructions or add corrections for inappropriate expressions so that the work instruction document conforms to the compliance rules, as compliance confirmation processing,
display the work instruction document confirmed by the compliance confirmation processing on a display interface, receive, from the user, confirmation of the work instruction document and additional input or correction input including a work deadline, responsible personnel information, and caution information, and update the work instruction document based on the additional input or correction input, as user interface processing, and
determine target workers and distribution media for the updated work instruction document, generate the work instruction document as electronic terminal data or print data, and transmit the work instruction document to an information processing apparatus used by the target workers, as distribution preparation processing.

### (Supplementary 2)

The system according to supplementary 1,
wherein the processor is configured to
analyze input information including the instruction received from the user, assign attribute information indicating an operation type, a priority, and an operation location to the instruction, construct the prompt sentence to be input to the generative AI model based on the input information and the attribute information, receive natural language text output from the generative AI model in response to the prompt sentence, and automatically classify the natural language text into a plurality of items including an operation objective, operation steps, required resources, and safety cautions, and store the classified items as the draft work instruction document.

### (Supplementary 3)

The system according to supplementary 1,
wherein the processor is configured to
detect expressions relating to an operation height, a handled object, and used equipment in the work instruction document, determine that the operation corresponds to work at a height exceeding a predetermined height or handling of a harmful substance, and, in response to the determination, automatically insert, into the work instruction document, template sentences relating to protective measures including wearing of a safety belt and wearing of protective equipment, and further receive, via the display interface, final confirmation of the work instruction document and manual corrections to the work instruction document from the user.

### Example 2

### (Supplementary 1)

A system comprising a processor,
wherein the processor is configured to
acquire operation information including an input start time, an input end time, a character count, an input speed, and a correction operation count associated with an input operation by a user, and acquire a prompt sentence input by the user, and generate emotion state data indicating an emotion state of the user by performing emotion analysis processing using a machine learning model and threshold determination processing based on the operation information and the prompt sentence,
generate an internal prompt sentence for input to a generative AI model by performing string processing that embeds the prompt sentence, the emotion state data, and tone designation information into predetermined positions of template text, and automatically generate a draft document including a subject and a body of a business electronic mail by performing natural language generation processing using the generative AI model based on the internal prompt sentence,
input body text of the draft document to a grammar analysis engine, obtain error information by performing syntactic analysis and spell-checking processing, and automatically correct grammar errors, spelling errors, and punctuation errors in the body text based on the error information,
when the emotion state data indicates anger or anxiety exceeding a predetermined threshold, detect emotional expressions by collating the body text with dictionary data in which emotional emphasis expressions are registered, and generate correction proposals including moderate alternative expressions by performing reference to a substitution table or paraphrase generation processing using the generative AI model based on a detection result,
perform morphological analysis processing and compliance dictionary collation processing on the body text, detect prohibited expressions, confidential-information-related expressions, and inappropriate expressions as compliance-violation candidate expressions, and generate, for each of the compliance-violation candidate expressions, a corresponding correction proposal and warning information,
generate display data including the draft document, the emotion state data, the correction proposals generated for the emotional expressions, and the compliance-violation candidate expressions, and control a user interface to perform preview display of the draft document, presentation of the correction proposals, and reception of manual correction operations by the user, and perform format verification processing for destination information, the subject, and attachment information based on a transmission instruction and the emotion state data, and, when the emotion state exceeds a predetermined threshold, determine whether to perform immediate transmission of the business electronic mail or to perform reconfirmation after holding transmission for a predetermined time, and control electronic mail transmission processing based on the determination.

### (Supplementary 2)

The system according to supplementary 1,
wherein the processor is configured to, when receiving update request data including a tone-relaxation instruction by the user, generate an internal prompt sentence including a current body text of the draft document, add a condition requesting rewriting into a considerate and moderate business electronic mail to the internal prompt sentence, input the internal prompt sentence to the generative AI model, and generate a new draft document in which only a tone is adjusted while original content is preserved, by performing re-analysis processing by the grammar analysis engine and the compliance processing on a rewritten body generated by the generative AI model.

### (Supplementary 3)

The system according to supplementary 1,
wherein the processor is configured to, based on the emotion state data at a time of transmission, when the emotion state is high, cause the user interface to present options including at least “immediate transmission” and “reconfirmation after a predetermined time,” and, in response to a reconfirmation selection by the user, execute transmission-hold control processing that causes re-preview display of the draft document and final transmission confirmation after elapse of the predetermined time by using a scheduler function.

### Application Example 2

### (Supplementary 1)

A system comprising a processor,
wherein the processor is configured to
acquire, from a user terminal, a prompt sentence indicating work content and an input operation history related to input of the prompt sentence,
estimate an emotional state and a behavioral state of a user by performing natural language processing on the prompt sentence and behavior analysis on the input operation history, and generate integrated emotion information by integrating the emotional state and the behavioral state,
determine control information, in accordance with the integrated emotion information, the control information defining at least a style of an input prompt sentence for a generative AI model, a level of detail, a structure, and a writing style of an output text of the generative AI model, and a display format on the user terminal,
construct, on the basis of the prompt sentence and the control information, an input prompt sentence to be supplied to the generative AI model, and automatically generate a business-related natural language text by using the generative AI model,
perform grammatical analysis on the automatically generated natural language text, detect grammatical errors, inconsistent notations, and unnatural expressions, and generate a corrected text as a result of automatic correction,
compare the corrected text with predetermined normative information, and generate a compliance-checked text by automatically supplementing missing cautions and inappropriate expressions on the basis of at least one of a safety standard and a compliance standard, generate user interface control information, in accordance with the integrated emotion information and the control information, the user interface control information defining at least a display format, emphasis portions, and expansion states of supplementary information for the compliance-checked text, and transmit the user interface control information and the compliance-checked text to the user terminal, and
convert, in response to a final approval instruction received from the user terminal, the compliance-checked text into work document data in a predetermined output format, and distribute the work document data to at least one of a work terminal and an output device.

### (Supplementary 2)

The system according to supplementary 1,
wherein the processor is configured to
perform a tokenization process on the prompt sentence to divide the prompt sentence into words or subword units, input a token sequence obtained by the tokenization process into a pre-trained language model, output scores for a plurality of emotion categories including at least stress, confusion, anxiety, and neutral, extract, from the input operation history, feature quantities including at least a total input time, a character count, a number of erroneous inputs, a number of re-edits, and an input time per character, input the feature quantities into a machine learning model, estimate behavioral state scores including at least an inattentiveness level, a hurry level, and a fatigue level, and determine the integrated emotion information, including at least a high-stress state or a confused state, on the basis of the emotion category scores and the behavioral state scores.

### (Supplementary 3)

The system according to supplementary 1,
wherein the processor is configured to
set, in determining the control information, a parameter for specifying a style in which the generative AI model presents work steps as concise bullet points and suppresses an amount of text when the integrated emotion information indicates a high-stress state, set a parameter for specifying a style in which the generative AI model describes work steps in detail in a stepwise manner and explicitly includes operation procedures and safety cautions when the integrated emotion information indicates at least one of a confused state and an anxious state, and generate, as the user interface control information, setting information defining at least emphasis display of main steps, visual emphasis of cautions, and presence or absence of automatic expansion of help information.

What is claimed is:

1. A system comprising:
circuitry configured to:
receive, via a communication interface coupled to a packet-switched network, instruction data from a terminal device and generate draft message data based on the instruction data using a generative neural network model;
perform linguistic analysis on the draft message data to detect errors including spelling errors, punctuation errors, and syntactic inconsistencies, and automatically correct the draft message data based on results of the linguistic analysis;
perform content validation on the corrected draft message data based on rule data and phrase data stored in a storage device coupled to the packet-switched network to detect expressions that violate predefined criteria, and generate warning data and correction candidate data for detected violations; and
transmit the corrected draft message data, the warning data, and the correction candidate data to the terminal device via the communication interface.

2. The system according to claim 1, wherein the circuitry analyzes the instruction data using a natural language processing model to extract purpose information, recipient type information, and tone specification information, and generates structured information encoding the extracted information for use in constructing a prompt data structure.

3. The system according to claim 2, wherein the circuitry constructs the prompt data structure encoding the structured information including the purpose information, the recipient type information, and the tone specification information, and transmits the prompt data structure to the generative neural network model comprising a transformer-based architecture with a plurality of self-attention layers to generate the draft message data.

4. The system according to claim 3, wherein the draft message data includes subject information, body text information, and suggested recipient address information, and wherein the generative neural network model generates the draft message data in a format conforming to a business electronic message standard.

5. The system according to claim 4, wherein the circuitry further retrieves context data from the storage device including past message data exchanged with a same recipient, and incorporates the context data into the prompt data structure to generate the draft message data with contextually consistent tone and terminology.

6. The system according to claim 1, wherein the linguistic analysis includes performing sentence division processing and language structure analysis processing on the draft message data to identify clause boundaries, subject-verb agreement errors, and tense inconsistencies.

7. The system according to claim 6, wherein the circuitry automatically corrects the detected errors by generating replacement text using the generative neural network model for syntactic inconsistencies and using dictionary-based lookup for spelling errors, and inserts correction annotations into the draft message data indicating original text and replacement text for each correction.

8. The system according to claim 7, wherein the circuitry further analyzes tone consistency across paragraphs of the draft message data and adjusts formality level of individual paragraphs to maintain uniform tone throughout the corrected draft message data.

9. The system according to claim 1, wherein the rule data includes enterprise compliance rules specifying prohibited expressions, confidentiality protection criteria identifying categories of protected information, and wording standards defining appropriate expression patterns for organizational communication.

10. The system according to claim 9, wherein the circuitry detects specific keywords and phrases in the corrected draft message data that match entries in the phrase data, determines whether each detected keyword or phrase violates the confidentiality protection criteria or the wording standards, and generates the warning data associating each violation with a severity level and a text location within the draft message data.

11. The system according to claim 10, wherein the circuitry generates the correction candidate data by constructing an updated prompt data structure encoding the detected violation and the associated rule, transmitting the updated prompt data structure to the generative neural network model, and receiving replacement text that satisfies the predefined criteria while preserving the intended meaning of the original expression.

12. The system according to claim 1, wherein the circuitry transmits display information to the terminal device formatted to present the corrected draft message data with inline annotations highlighting detected violations and associated correction candidates, and provides an interface enabling the user to accept, reject, or modify each correction candidate.

13. The system according to claim 12, wherein the circuitry receives additional instruction data from the terminal device requesting modifications to the corrected draft message data, constructs an updated prompt data structure encoding the modifications and the current draft, transmits the updated prompt data structure to the generative neural network model, and generates revised draft message data incorporating the requested modifications.

14. The system according to claim 1, wherein the circuitry is further configured to receive finalized message data from the terminal device, verify conformity of address information, subject information, and attachment information in the finalized message data against format conditions and constraint conditions stored in the storage device, and transmit the finalized message data to a message transfer device via the communication interface according to a transmission protocol.

15. The system according to claim 14, wherein the circuitry blocks transmission of the finalized message data and transmits a notification to the terminal device when the address information includes an external domain not present in an approved domain list stored in the storage device, or when attachment information exceeds a size threshold or contains a file type identified as restricted.

16. The system according to claim 1, wherein the circuitry is further configured to store the finalized message data and associated correction history in the storage device, and to update the rule data and the phrase data based on patterns identified in the correction history across a plurality of message generation sessions.

17. The system according to claim 16, wherein the circuitry estimates a proficiency level of the user based on a frequency and type of corrections applied across the plurality of message generation sessions, and adjusts a level of detail of the warning data and the correction candidate data based on the estimated proficiency level, providing more detailed explanations for users with lower estimated proficiency levels.

18. A system comprising:
a communication interface including a network interface controller coupled to a packet-switched network and configured to transmit and receive data packets;
a memory storing instructions, a generative neural network model comprising a transformer architecture with a plurality of self-attention layers, rule data specifying compliance criteria, phrase data specifying prohibited and protected expressions, and message history data; and
circuitry comprising one or more processors coupled to the memory and configured to execute the instructions to:
receive, via the communication interface, instruction data from a terminal device, analyze the instruction data to extract purpose and tone information, and construct a prompt data structure encoding the extracted information;
generate draft message data by transmitting the prompt data structure to the generative neural network model;
perform linguistic analysis on the draft message data to detect and automatically correct spelling errors, punctuation errors, and syntactic inconsistencies;
perform content validation on the corrected draft message data based on the rule data and the phrase data to detect expressions violating predefined criteria, and generate warning data and correction candidate data;
transmit the corrected draft message data, the warning data, and the correction candidate data to the terminal device via the communication interface; and
receive finalized message data from the terminal device, verify conformity against format and constraint conditions, and transmit the finalized message data to a message transfer device.

19. The system according to claim 18, wherein the circuitry is further configured to estimate a proficiency level of the user based on correction history data, and to adjust a level of detail of the warning data and the correction candidate data based on the estimated proficiency level.

20. A method performed by circuitry of a server coupled to a packet-switched network via a communication interface, the method comprising:
receiving, via the communication interface, instruction data from a terminal device and generating draft message data based on the instruction data using a generative neural network model;
performing linguistic analysis on the draft message data to detect errors including spelling errors, punctuation errors, and syntactic inconsistencies, and automatically correcting the draft message data based on results of the linguistic analysis;
performing content validation on the corrected draft message data based on rule data and phrase data stored in a storage device coupled to the packet-switched network to detect expressions that violate predefined criteria, and generating warning data and correction candidate data for detected violations; and
transmitting the corrected draft message data, the warning data, and the correction candidate data to the terminal device via the communication interface.
